(19) United States
(12) Patent Application Publication
(10) Pub. No.: US 2013/0057914 A1
(43) Pub. Date: Mar. 7, 2013

(54) IMAGE FORMING APPARATUS AND NON-TRANSITORY COMPUTER READABLE RECORDING MEDIUM STORED WITH CONTROL PROGRAM FOR IMAGE FORMING APPARATUS

(71) Applicant: Kazuhisa KISHIMOTO, Tokyo (JP)

(72) Inventor: Kazuhisa KISHIMOTO, Tokyo (JP)

(21) Appl. No.: 13/599,426

(22) Filed: Aug. 30, 2012

(30) Foreign Application Priority Data
Sep. 2, 2011 (JP) 2011-191710

(51) Int. Cl. G06K 15/02

(52) U.S. Cl. 358/1.15

(57) ABSTRACT

An image forming apparatus has: a display unit that can switch and display a plurality of operation screens, including an operation screen to display elements constituting the operation screen in three dimensional display; a storage unit that stores image data of a page image; a receiving unit that receives a command to display the page image in the display unit; and a display control unit that, when the command is received by the receiving unit and an operation screen for displaying the page image, among the plurality of operation screens, is displayed in the display unit, generates the page image based on the image data that is stored in the storage unit, on the operation screen, as an image for two dimensional display.

### CROSS-REFERENCE TO RELATED APPLICATION

This application is based on Japanese Patent Application No. 2011-191710, filed on Sep. 2, 2011, the contents of which are incorporated herein by reference.

### BACKGROUND

1. Technical Field

The present invention relates to an image forming apparatus having a display unit which can display three-dimensional images, and a non-transitory computer readable recording medium stored with a control program for the image forming apparatus.

2. Description of Related Art

In recent years, more devices, including liquid crystal televisions to start with, and mobile telephones and game machines, have come to have a display unit which can display three dimensional stereoscopic images.

As a technique related to this, various techniques of combining three-dimensional image display and two-dimensional image display have been proposed. For example, Unexamined Japanese Patent Publication No. 2010-283715 discloses a technique, whereby, when display information is going to be displayed on a display unit that supports three dimensional display, whether or not that display information is adequate for three dimensional display is determined based on the content of the display information, and, when the display information is determined to be adequate for three dimensional display, the display information is displayed in three dimensional display. Also, Unexamined Japanese Patent Publication No. H5-284542 discloses a technique of combining a three-dimensional image and a two-dimensional image and displaying them on a display screen at the same time.

However, assuming applying a technique of combining three-dimensional image display and two-dimensional image display to the operation panel unit of an image forming apparatus such as a copy machine and MFP (Multi-Function Peripheral), the techniques disclosed in Unexamined Japanese Patent Publication No. 2010-283715 and Unexamined Japanese Patent Publication No. H5-284542 both fail to make proposals as to how to separate three-dimensional image display and two-dimensional image display and apply to an operation panel unit. That is to say, nothing is known about display that combines a three-dimensional image and a two-dimensional image and that is special and unique to an image forming apparatus.

### SUMMARY

The present invention has been made in view of the above backgrounds. It is therefore an object of the present invention to provide an image forming apparatus, whereby a three-dimensional image and a two-dimensional image are combined adequately and displayed on a display unit, and a non-transitory computer readable recording medium stored with a control program for the image forming apparatus.

To achieve at least one of the abovementioned objects, an image forming apparatus reflecting one aspect of the present invention includes: a display unit capable of switching and displaying a plurality of operation screens, including an operation screen to display elements constituting the operation screen in three dimensional display; a storage unit that stores image data of a page image; a receiving unit that receives a command to display the page image in the display unit; and a display control unit that, when the command is received by the receiving unit and an operation screen for displaying the page image, among the plurality of operation screens, is displayed in the display unit, generates the page image based on the image data that is stored in the storage unit, on the operation screen, as an image for two dimensional display.

The storage unit may preferably store image data of a plurality of page images; on the operation screen for displaying the page image, a plurality of thumbnail images corresponding to the image data of the plurality of page images may preferably be generated, and the page image that is displayed in two dimensional display may preferably be a page image corresponding to one thumbnail image that is selected from among the plurality of thumbnail images; and the display control unit may preferably further execute a control for generating the one thumbnail image that is selected from the plurality of thumbnail images as an image for two dimensional display, and generating the rest of the thumbnail images as images for three dimensional display.

An image forming unit that forms an image based on the image data on a recording medium; and a post-processing unit that applies post-processing to the recording medium on which the image is formed by the image forming unit may preferably be further included; the plurality of operation screens may preferably include an operation screen for setting up the post-processing; and the display control unit may preferably further execute a control for generating, according to the content of the post-processing, an image to represent a form of the recording medium to which the post-processing of the content has been applied, as an image for three dimensional display or as an image for two dimensional display, on the operation screen for setting up the post-processing.

The plurality of operation screens may preferably include an operation screen for displaying a message for a user; and the display control unit may preferably further execute a control for generating the message as an image for three dimensional display, on the operation screen for displaying the message.

The plurality of operation screens may preferably include an operation screen for displaying an instructional image for instructing a method of cancelling an error that has occurred in the image forming apparatus to a user; and the display control unit may preferably further execute a control for generating the instructional image as an image for three dimensional display, on the operation screen for displaying the instructional image.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a schematic front view showing a structure of an MFP according to the first embodiment of the present invention.

FIG. 2 is a block diagram showing a structure of the MFP shown in FIG. 1.

FIG. 3 is a diagram showing an example of an operation panel unit of an MFP.

FIG. 4 is a diagram showing a reference table that is stored in a storage unit of an MFP.

FIG. 5 is a flowchart to show the steps of the display control process that is executed by an MFP.

FIG. 6 is a diagram showing a standby screen that is displayed in an operation panel unit.

FIG. 7 is a diagram showing a preview screen that is displayed in an operation panel unit.

FIG. 8 is a diagram showing a setting content check screen that is displayed in an operation panel unit.

FIG. 9 is a diagram showing a use status check screen that is displayed in an operation panel unit.

FIG. 10 is a flowchart to show the steps of the 3D/2D screen display process shown in step S102 and step S111 in FIG. 5.

FIG. 11 is a flowchart to show the steps of the joint screen display process shown in step S202 in FIG. 10.

FIG. 12 is a diagram showing a reference table according to the second embodiment of the present invention.

FIG. 13 is a diagram showing a preview screen that is displayed based on the reference table shown in FIG. 12.

FIG. 14 is a diagram showing a reference table according to the third embodiment of the present invention.

FIG. 15 is a diagram showing a preview screen that is displayed based on the reference table shown in FIG. 14.

FIG. 16 is a diagram showing a reference table according to the fourth embodiment of the present invention.

FIG. 17 is a diagram showing a preview screen that is displayed based on the reference table shown in FIG. 16.

FIG. 18 is a diagram showing a reference table according to the fifth embodiment of the present invention.

FIG. 19 is a flowchart to show the steps of the display control process according to the fifth embodiment of the present invention.

FIG. 20 is a flowchart that is subsequent to FIG. 19.

FIG. 21 is a diagram showing a standby screen according to the fifth embodiment of the present invention.

FIG. 22 is a diagram showing a 3D-finishing icon display screen that is displayed in an operation panel unit.

FIG. 23 is a diagram showing a 2D-finishing icon display screen that is displayed in an operation panel unit.

FIG. 24 is a diagram showing a preview screen according to the fifth embodiment of the present invention.

FIG. 25 is a diagram showing a setting content check screen according to the fifth embodiment of the present invention.

FIG. 26 is a diagram showing a use status check screen according to the fifth embodiment of the present invention.

FIG. 27 is a diagram showing a help pop-up screen that is displayed in an operation panel unit.

FIG. 28 is a diagram showing a screen tree pop-up screen that is displayed in an operation panel unit.

FIG. 29 is a diagram showing an operation error warning screen that is displayed in an operation panel unit.

FIG. 30 is a diagram showing a guidance screen that is displayed in an operation panel unit.

FIG. 31 is a diagram showing a reference table according to the sixth embodiment of the present invention.

FIG. 32 is a diagram showing a guidance screen that is displayed based on the reference table shown in FIG. 31.

FIG. 33 is a flowchart to show the steps of the display operation mode selection process that is executed by an MFP.

FIG. 34 is a flowchart to show the steps of the display operation mode selection process according to the eighth embodiment of the present invention.

FIG. 35 is a diagram showing a visual mode first reference table.

FIG. 36 is a diagram showing a standby screen that is displayed based on the visual mode first reference table shown in FIG. 35.

FIG. 37 is a diagram showing a visual mode second reference table.

FIG. 38 is a diagram showing a standby screen that is displayed based on the visual mode second reference table shown in FIG. 37.

### DETAILED DESCRIPTION

The embodiments of this invention will be described below with reference to the accompanying drawings.

### First Embodiment

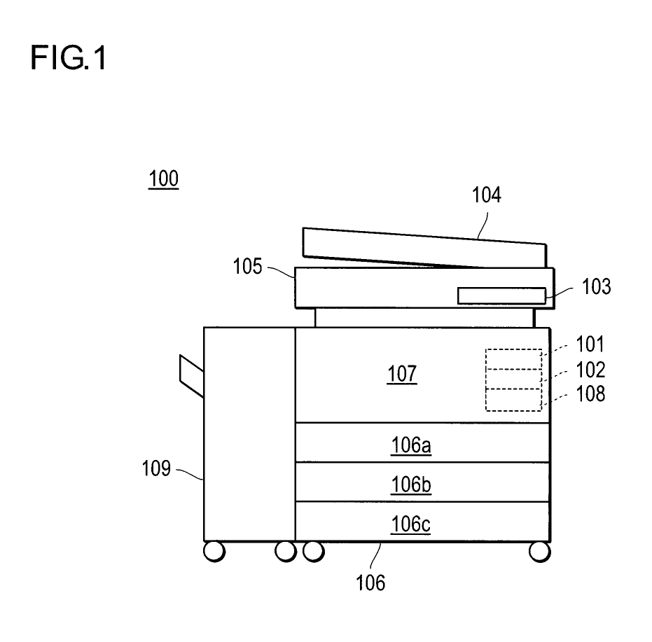

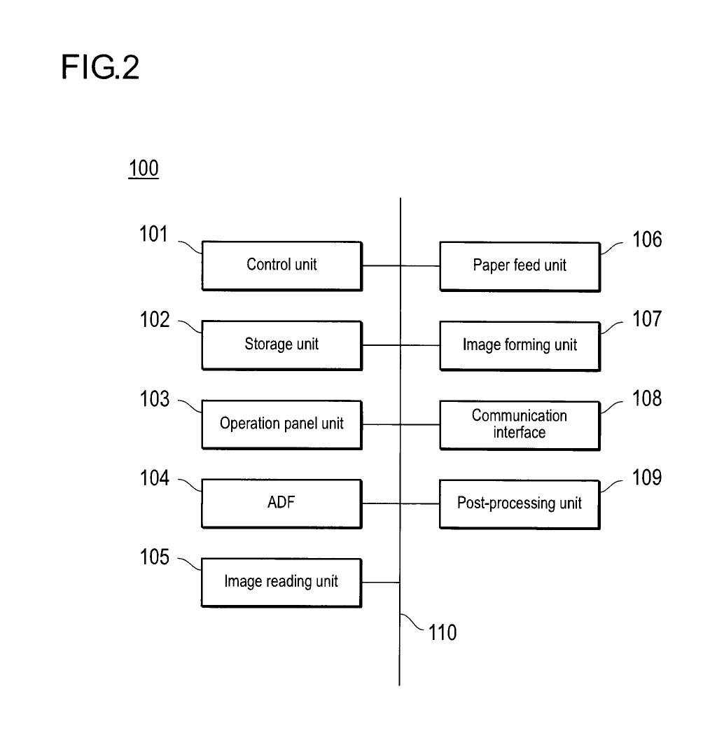

FIG. 1 is a schematic front view showing a structure of an MFP according to the first embodiment of the present invention, and FIG. 2 is a block diagram showing a structure of the MFP shown in FIG. 1.

As shown in FIG. 1 and FIG. 2, an MFP 100 has a control unit 101, a storage unit 102, an operation panel unit 103, an ADF (Auto Document Feeder) 104, an image reading unit 105, a paper feed unit 106, an image forming unit 107, a communication interface 108 and a post-processing unit 109, and these are connected with each other via a bus 110 to exchange signals.

The control unit 101 is a CPU (Central Processing Unit), and controls the above various units and performs various calculation processes according to programs. The storage unit 102 is formed with a ROM (Read Only Memory) that stores various programs and various data in advance, a RAM (Random Access Memory) that serves as a work space to store programs and data on a temporary basis, a hard disk that stores various programs and various data to control the fundamental operations of the MFP 100, and so on.

The operation panel unit 103 has a touch panel, ten-keys, a start button, a stop button and so on, and is used to display various kinds of information and input various commands.

The ADF 104 transports a plurality of sheets of documents that are set, to a predetermined reading position of the image reading unit 105, sequentially, one sheet at a time, and discharges the documents after image reading.

The image reading unit 105 illuminates a document that is set in a predetermined reading position, or a document that is transported by the ADF 104 to a predetermined reading position, by a light source such as a fluorescent lamp, performs an opto-electric conversion of the reflected light by an imaging device such as a CCD imaging sensor, and generates image data from the electrical signal.

The paper feed units 106a to 106c accommodate a recording medium such as paper used for printing. The paper feed unit 106 (which correctively refers to 106a to 106c) sends out the accommodated paper to the image forming unit 107, one sheet at a time.

The image forming unit 107 forms images on a recording medium such as paper, based on various data, using known imaging processes such as electronic photographic processes including the steps of electrical charging, exposure, developing, transferring and fixing.

The communication interface 108 is an interface for communicating with other devices, and adopts a standard such as Ethernet, TokenRing, FDDI (Fiber Distributed Data Interface) and so on.

The post-processing unit 109 performs finishing processes to be applied to the paper after printing that is transported from the image forming unit 107. The finishing processes include the punching process to punch out holes for filing in an edge part of paper, and the folding process to fold paper from the center part.

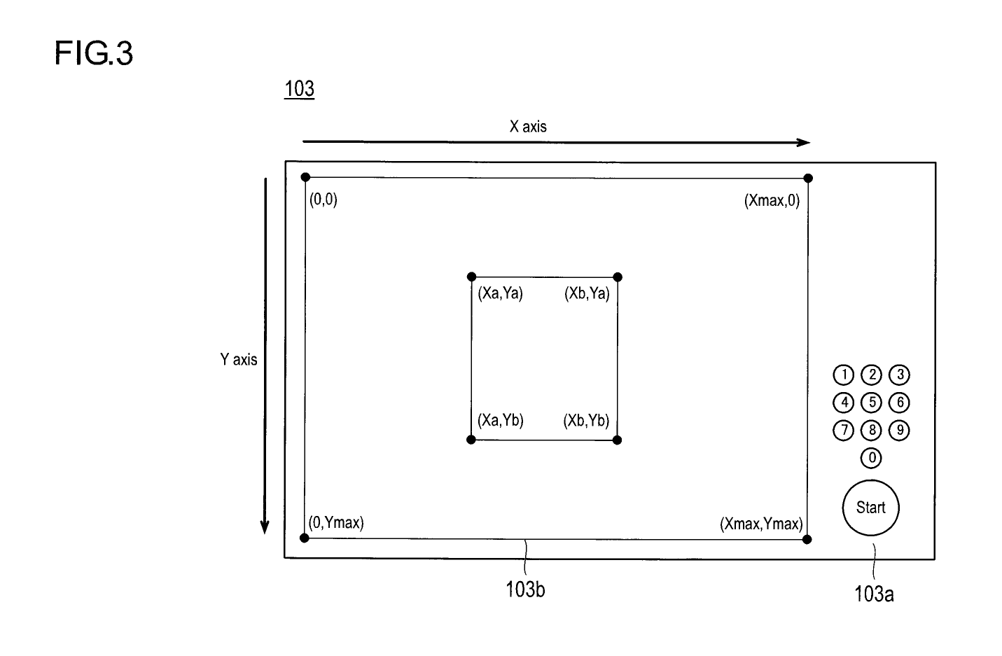

FIG. 3 is a diagram showing an example of the operation panel unit of the MFP shown in FIG. 1. The operation panel unit 103 has an operation unit 103a and a 3D/2D display unit 103b.

The operation unit 103a has, for example, ten-keys, a start button and a stop button, and is used to input various commands.

The 3D/2D display unit 103b is formed with a liquid crystal touch panel, and is used to display various kinds of information and input various commands. The 3D/2D display unit 103b is configured to switch and display a plurality of operation screens, and, on each operation screen, device information of the MFP 100 and elements (parts) such as operation buttons for setting up the operation conditions are displayed in three dimensional display or two dimensional display. The 3D/2D display unit 103b can display a three-dimensional image and a two-dimensional image on one operation screen, at the same time. The 3D/2D display unit 103b has a two dimensional arrangement structure, in which the origin is located in the upper left of FIG. 3, the X axis runs from the left to the right and the Y axis runs from the top toward the bottom.

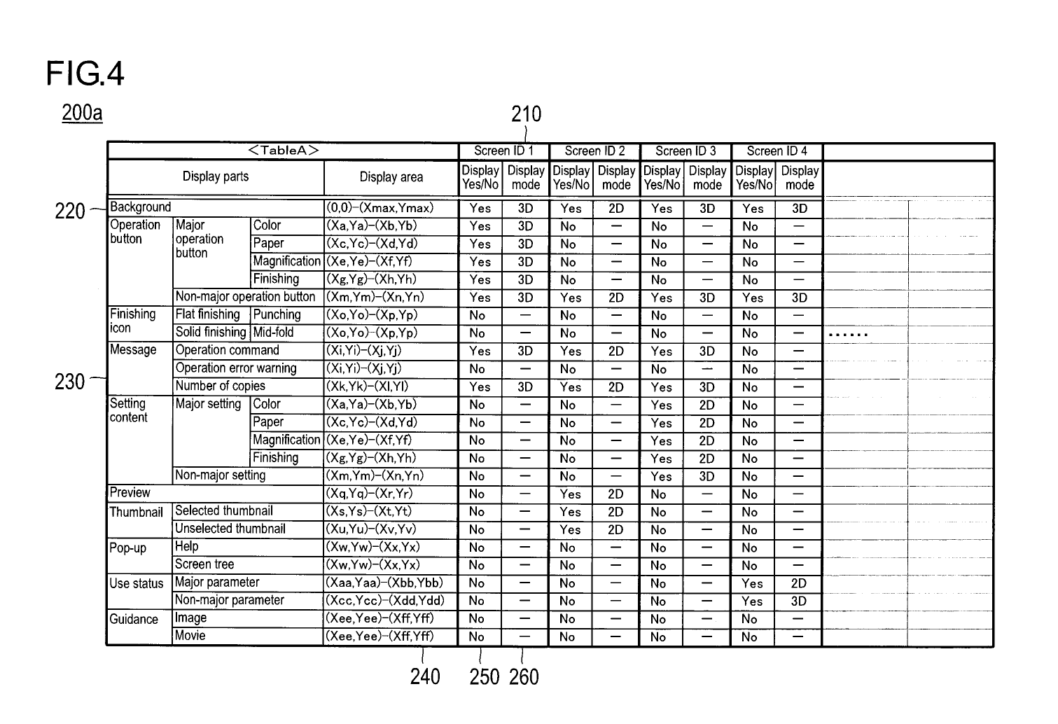

FIG. 4 is a diagram showing a reference table that is stored in the storage unit of the MFP. The reference table 200a is used to determine the display mode (three dimensional display or two dimensional display) of each element constituting the operation screen to be displayed in operation panel unit 103.

The reference table 200a includes screen ID information 210, background information 220, part information 230, display position information 240, display feasibility information 250, and display mode information 260.

The screen ID information 210 is information for identifying a plurality of operation screens that are switched and displayed in the operation panel unit 103. Screen ID 1 to screen ID 4 in FIG. 4 correspond to a standby screen, a preview screen, a setting content check screen, and a use status check screen, respectively.

The background information 220 is information to show the display mode (three dimensional display or two dimensional display) of the background image on each operation screen.

The part information 230 is information to show the elements to constitute each operation screen such as operation buttons and messages, and the display position information 240 is information for specifying the position (coordinates) of each element to be displayed on the operation screens.

The display feasibility information 250 is information to show whether or not each element shown in the part information 230 is displayed on an operation screen, and the display mode information 260 is information to show the display mode (three dimensional display or two dimensional display) of each element.

Note that the MFP 100 may include components other than the above components, or may not include part of the above components.

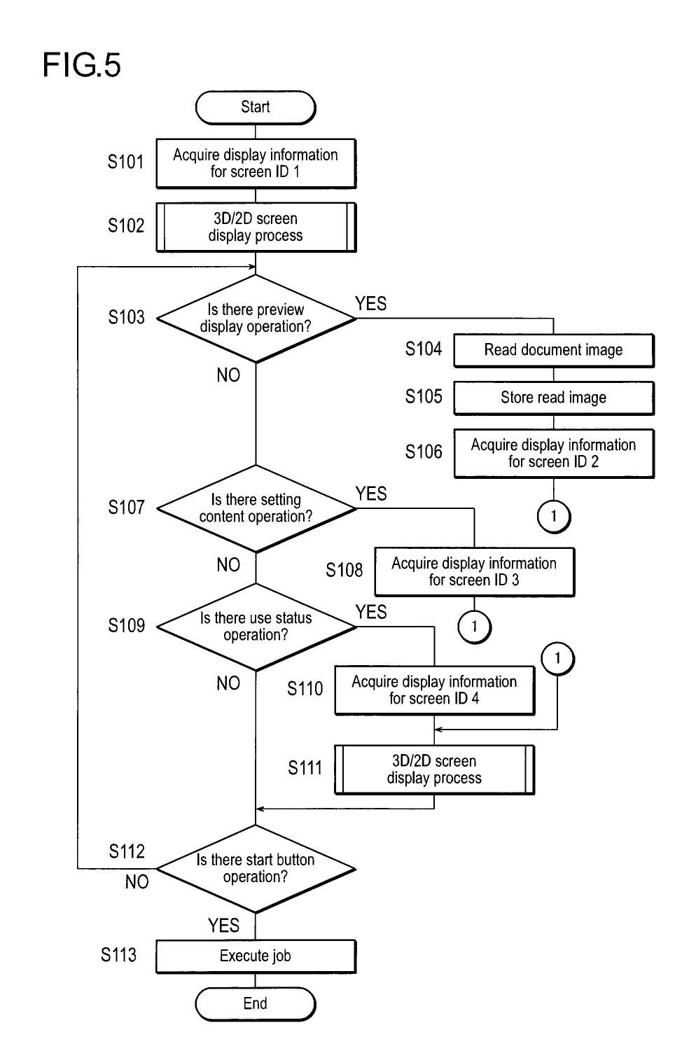

With the MFP 100 structured as described above, elements such as operation buttons and messages are displayed in three dimensional display or two dimensional display, on operation screens to be displayed in the operation panel unit 103. Now, the operations of the MFP 100 will be described below with reference to FIG. 5 to FIG. 11.

FIG. 5 is a flowchart to show the steps of the display control process that is executed by the MFP. Note that the algorithm represented by the flowchart of FIG. 5 is stored as a program in the storage unit 102 of the MFP 100, and is executed by the control unit 101.

First, display information for screen ID 1 is acquired (step S101). In the present embodiment, following the activation of the MFP 100, background information 220, part information 230, display position information 240, display feasibility information 250 and display mode information 260 that are associated with screen ID 1 are acquired from the reference table 200a, as display information for screen ID 1.

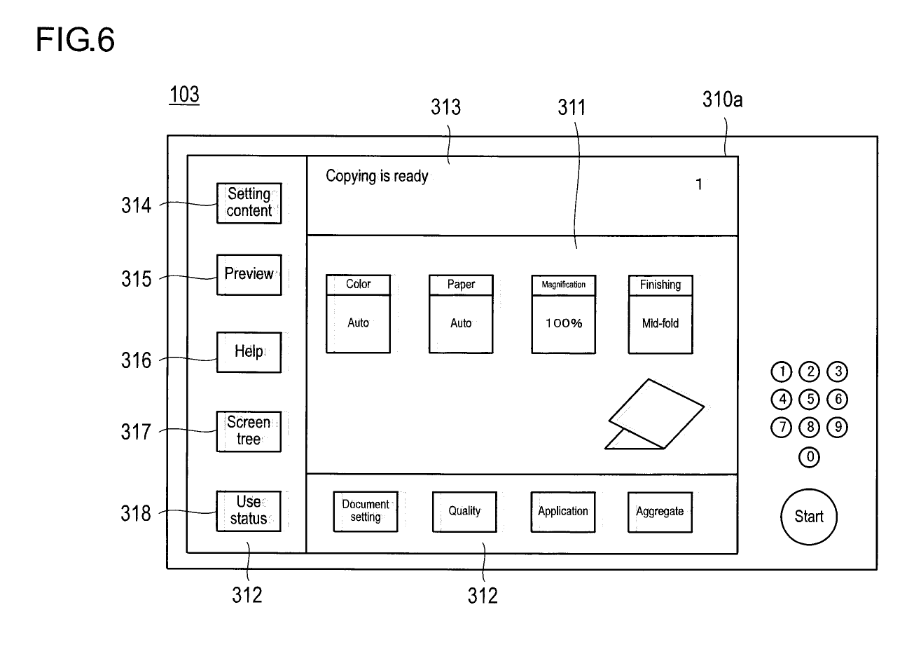

Next, a 3D/2D screen display process is executed (step S102). In the present embodiment, the 3D/2D screen display process is executed based on the display information that was acquired in the process shown in step S101. As the 3D/2D screen display process is executed, a standby screen 310a (see FIG. 6) is displayed in the operation panel unit 103. The 3D/2D screen display process shown in step S102 will be described later in detail.

FIG. 6 is a diagram showing a standby screen that is displayed in the operation panel unit. The standby screen 310a includes a major operation button display unit 311, a non-major operation button display unit 312 and a message display unit 313.

The major operation button display unit 311 displays major operation buttons such as a color selection button, a paper selection button, a magnification setting button, a finishing setting button and so on. The non-major operation button display unit 312 displays non-major operation buttons such as a setting content check button 314, a preview button 315, a help button 316, a screen tree button 317, a use status check button 318, a document setting button, a picture quality setting button, an application setting button, an aggregate setting button and so on. The message display unit 313 displays the operation command message “copying is ready” and messages such as the number of copies. The standby screen 310a of the present embodiment displays images of the major operation buttons, images of the non-major operation buttons and messages, all in three dimensional display, according to the display mode information 260 of the reference table 200a.

In the event the standby screen 310a is displayed in the process shown in step S102, whether or not there is a preview display operation is determined (step S103). In the present embodiment, whether or not the preview button 315 on the standby screen 310a, displayed in the process shown in step S102, is touched by the user is determined.

In the event it is determined that there is no preview display operation (step S103: NO), the step moves on to the process of step S107. On the other hand, in the event it is determined that there is a preview display operation (step S103: YES), the image on the document is read (step S104). In the present embodiment, for example, a document that is set in advance in the ADF 104 of the MFP 100 is transported to the image reading unit 105, and the image on the document is read by the image reading unit 105.

Next, the read image is stored (step S105). In the present embodiment, the image data that was acquired in the process shown in step S104 by reading the image on the document, is stored in the storage unit 102.

Next, display information for screen ID 2 is acquired (step S106). In the present embodiment, background information 220, part information 230, display position information 240, display feasibility information 250, and display mode information 260 that are associated with screen ID 2, are acquired from the reference table 200a, as display information for screen ID 2.

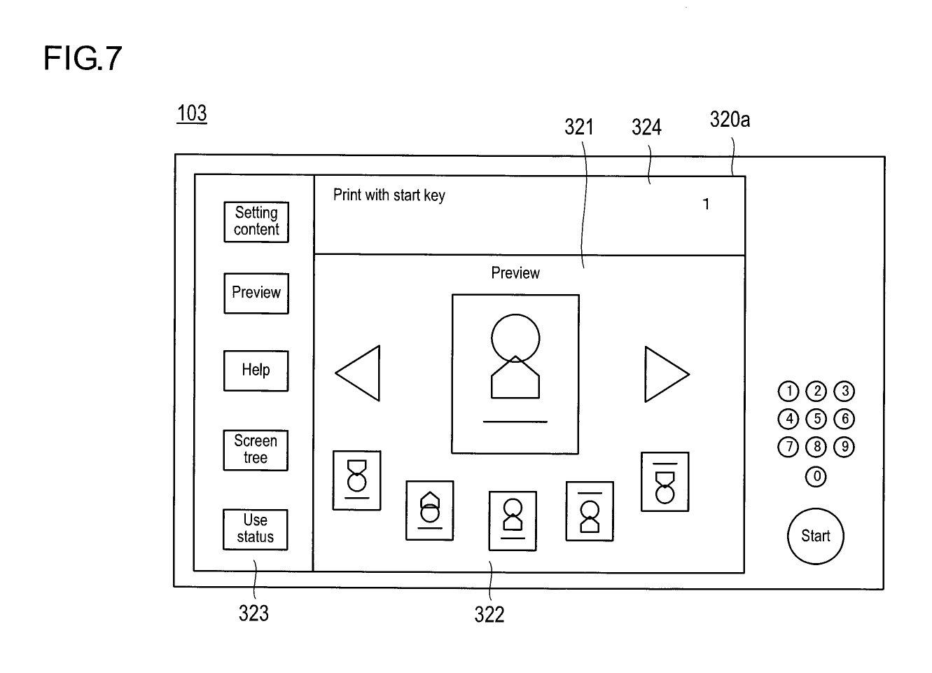

Next, a 3D/2D screen display process is executed (step S111). In the present embodiment, the 3D/2D screen display process is executed based on the display information that was acquired in the process shown in step S106. As the 3D/2D screen display process is executed, a preview screen 320a (see FIG. 7) is displayed in the operation panel unit 103.

FIG. 7 is a diagram showing a preview screen that is displayed in the operation panel unit. The preview screen 320a has a preview image display unit 321, a thumbnail image display unit 322, a non-major operation button display unit 323 and a message display unit 324.

The preview image display unit 321 displays, as a preview image, an image that is based on the image data that is acquired by reading the image of the document by the image reading unit 105. The thumbnail image display unit 322 displays a plurality of thumbnail images. A plurality of thumbnail images are displayed in the event a plurality of pages of documents are read by the image reading unit 105, and one image selected from the plurality of thumbnail images is enlarged and displayed as a preview image. The non-major operation button display unit 323 displays non-major operation buttons such as a setting content check button, a preview button, a help button, a screen tree button, a use status check button and so on. The message display unit 324 displays the operation command message “Print with start key” and messages such as the number of copies.

The preview screen 320a of the present embodiment displays a preview image, thumbnail images, images of the non-major operation buttons, and messages, all in two dimensional display, according to the display mode information 260 of the reference table 200a. As a preview image is displayed in two dimensional display, higher resolution than three dimensional display is achieved, so that the user is able to recognize the content of the preview image accurately.

On the other hand, in the process shown in step S103, in the event it is determined that there is no preview display operation (step S103: NO), whether or not there is a setting content check operation is determined (step S107). In the present embodiment, whether or not the setting content check button 314 on the standby screen 310a, displayed in the process shown in step S102, is touched by the user is determined.

In the event it is determined that there is no setting content check operation (step S107: NO), the step moves on to the process of step S109. On the other hand, in the event it is determined that there is a setting content check operation (step S107: YES), display information for screen ID 3 is acquired (step S108). In the present embodiment, background information 220, part information 230, display position information 240, display feasibility information 250, and display mode information 260 that are associated with screen ID 3 are acquired from the reference table 200a as display information for screen ID 3.

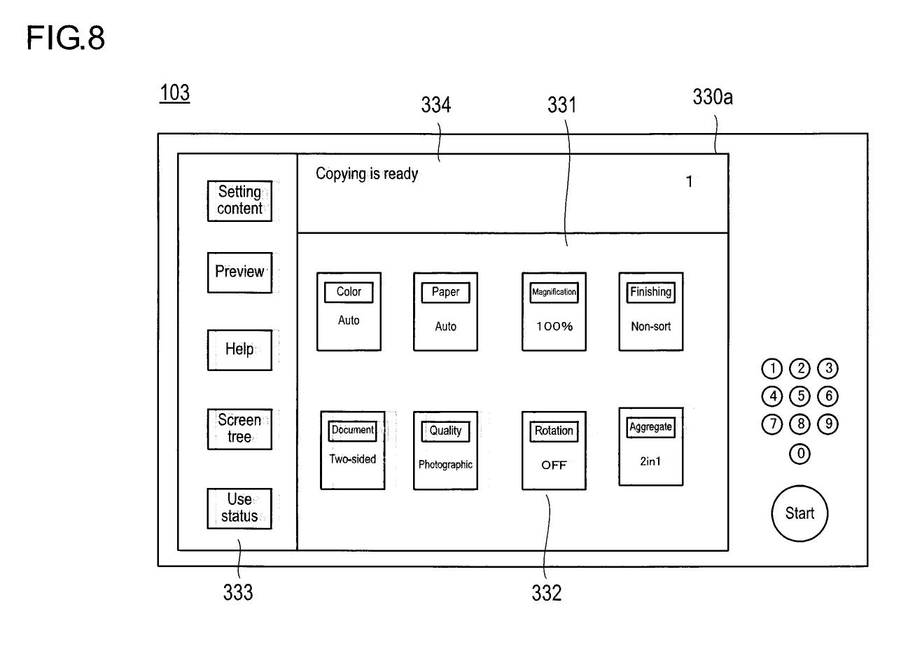

Next, a 3D/2D screen display process is executed (step S111). In the present embodiment, the 3D/2D screen display process is executed based on the display information that was acquired in the process shown in step S108. As the 3D/2D screen display process is executed, a setting content check screen 330a (see FIG. 8) is displayed in the operation panel unit 103.

FIG. 8 is a diagram showing a setting content check screen that is displayed in the operation panel unit. The setting content check screen 330a has a major setting display unit 331, a non-major setting display unit 332, a non-major operation button display unit 333 and a message display unit 334.

The major setting display unit 331 displays major setting buttons such as a color selection button, a paper selection button, a magnification setting button, a finishing setting button and so on. The non-major setting display unit 332 displays non-major setting buttons such as a document setting button, a picture quality setting button, a rotation setting button, an aggregate setting button and so on. The non-major operation button display unit 333 displays non-major operation buttons such as a setting content check button, a preview button, a help button, a screen tree button, a use status check button and so on. The message display unit 334 displays the operation command message “copying is ready” and messages such as the number of copies.

The setting content check screen 330a of the present embodiment displays images of the non-major setting buttons, images of the non-major operation buttons and messages in three dimensional display, while displaying images of the major setting buttons in two dimensional display, according to the display mode information 260 of the reference table 200a. According to this structure, the major setting buttons are displayed differently from the other elements and are therefore emphasized, so that the user is able to recognize the major setting buttons easily.

On the other hand, in the process shown in step S107, in the event it is determined that there is no setting content check operation (step S107: NO), whether or not there is a use status check operation is determined (step S109). In the present embodiment, whether or not the use status check button 318 on the standby screen 310a, displayed in the process shown in step S102, is touched by the user is determined.

In the event it is determined that there is no use status check operation (step S109: NO), the step moves on to the process of step S112. On the other hand, in the event it is determined that there is a use status check operation (step S109: YES), display information for screen ID 4 is acquired (step S110). In the present embodiment, background information 220, part information 230, display position information 240, display feasibility information 250, and display mode information 260 that are associated with screen ID 4 are acquired from the reference table 200a as display information for screen ID 4.

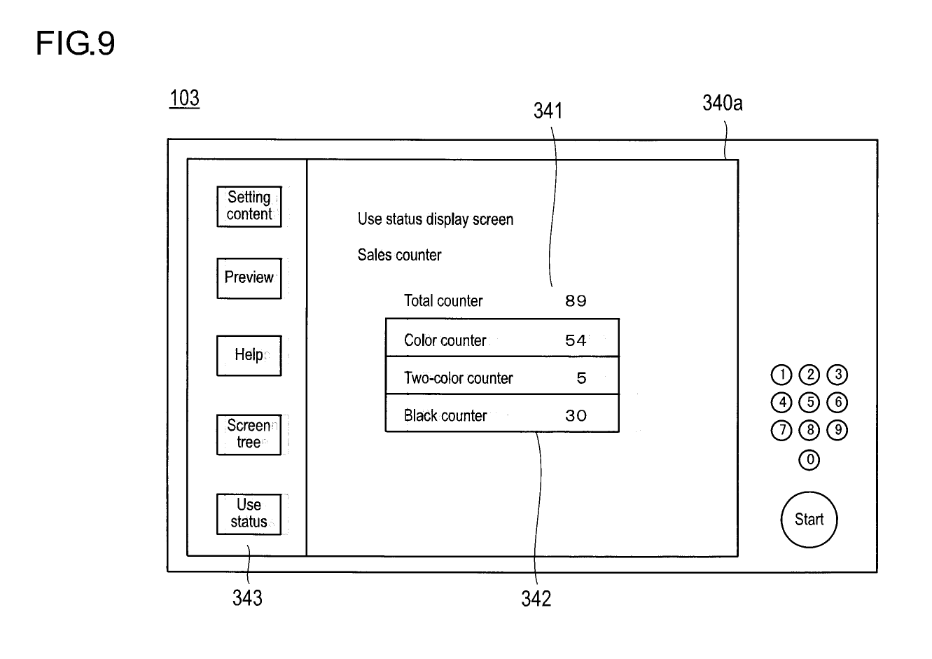

Next, a 3D/2D screen display process is executed (step S111). In the present embodiment, the 3D/2D screen display process is executed based on the display information that was acquired in the process shown in step S110. As the 3D/2D screen display process is executed, a use status check screen 340a (see FIG. 9) is displayed in the operation panel unit 103.

FIG. 9 is a diagram showing a use status check screen that is displayed in the operation panel unit. The use status check screen 340a has a major parameter display unit 341, a non-major parameter display unit 342, and a non-major operation button display unit 343.

The major parameter display unit 341 displays major parameters such as total counter information. The non-major parameter display unit 342 displays non-major parameters such as color counter information, two-color counter information and black counter information. The non-major operation button display unit 343 displays non-major operation buttons such as a setting content check button, a preview button, a help button, a screen tree button, a use status check button and so on.

The use status check screen 340a of the present embodiment displays the non-major parameters and images of non-major operation buttons in three dimensional display, while displaying the major parameters in two dimensional display. According to this structure, the major parameters are displayed differently from the other elements and are therefore emphasized, so that the user is able to recognize the major parameters easily.

On the other hand, in the process shown in step S109, in the event it is determined that there is no use status check operation (step S109: NO), whether or not there is a start button operation is determined (step S112). In the present embodiment, whether or not the start button provided in the operation unit 103a of the operation panel unit 103 is pressed by the user is determined.

In the event it is determined that there is no start button operation (step S112: NO), the step returns to the process of step S103. On the other hand, in the event it is determined that there is a start button operation (step S112: YES), a job is executed (step S113), and the process is finished. In the present embodiment, an image that is read from a document and displayed as a preview image is printed out by the image forming unit 107.

As described above, according to the processes of the flowchart shown in FIG. 5, a plurality of operation screens 310a, 320a, 330a and 340a are switched and displayed in the operation panel unit 103, based on user operations. At this time, elements such as the operation buttons and messages are displayed in three dimensional display, while part of elements such as preview images are displayed in two dimensional display.

Given this structure, compared to a case where a preview image is displayed in three dimensional display, an image of high resolution is achieved, so that the user is able to recognize the content of a preview image accurately. Note that displaying a preview image in two dimensional display is useful especially when the preview image contains many letters.

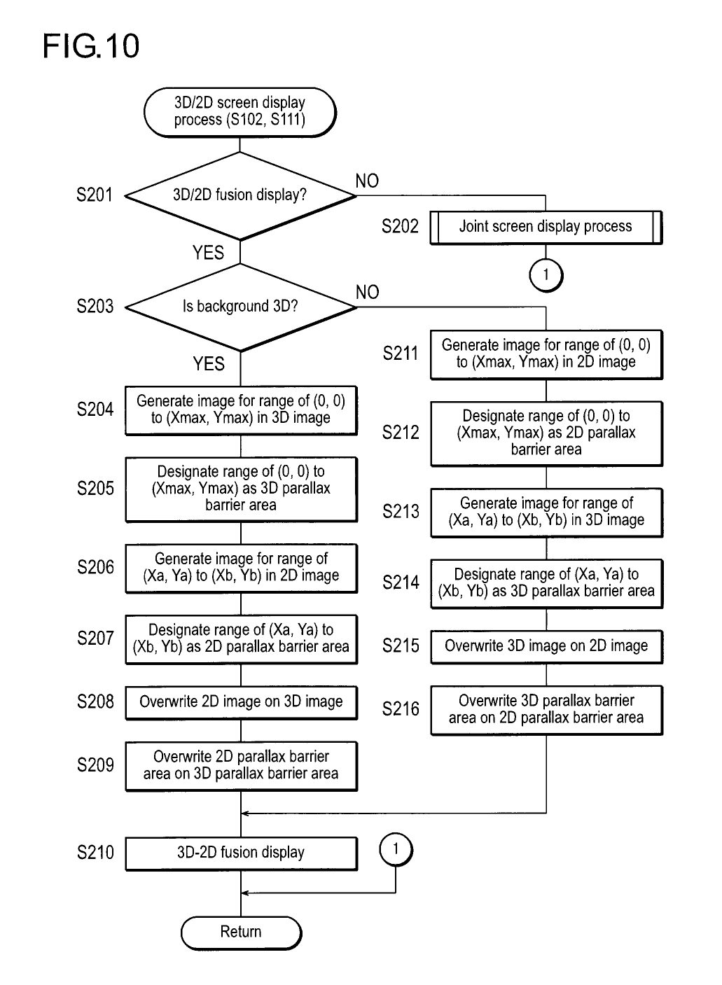

FIG. 10 is a flowchart to show the steps of the 3D/2D screen display process shown in step S102 and step S111 of FIG. 5. As described above, in the 3D/2D screen display process, an operation screen is displayed in the operation panel unit 103 based on display information of the reference table 200a.

First, whether or not 3D-2D fusion display is used is determined (step S201). In the present embodiment, whether the operation screen is formed with three-dimensional images or two-dimensional images alone or formed with both two-dimensional images and three-dimensional images is determined, based on the display mode information 260 of the reference table 200a.

In the event 3D-2D fusion display is determined not to be used (step S201: NO), a joint screen display process is executed (step S202). In the present embodiment, the joint screen display process is executed, and an operation screen that is formed with three-dimensional images or two-dimensional images alone is displayed in the operation panel unit 103. The joint screen display process shown in step S202 will be described later in detail.

On the other hand, in the process shown in step S201, in the event 3D-2D fusion display is determined to be used (step S201: YES), whether or not the background is three dimensional display is determined (step S203). In the present embodiment, whether the background is three dimensional display or two dimensional display is determined based on the background information 220 of the reference table 200a.

In the event the background is determined not to be three dimensional display (step S203: NO), the step moves on to the process of step S211. On the other hand, in the event the background is determined to be three dimensional display (step S203: YES), images in the range of the coordinates (0, 0) to (Xmax, Ymax) are generated as images for three dimensional display (step S204). In the present embodiment, all images constituting an operation screen are generated as images for three dimensional display.

Next, the range of the coordinates (0, 0) to (Xmax, Ymax) is designated as a parallax barrier area for three dimensional display (step S205). In the present embodiment, the entire area of an operation screen is designated as the area to generate a parallax barrier to allow three dimensional display.

Next, images in the range of the coordinates (Xa, Ya) to (Xb, Yb) are generated as images for two dimensional display (step S206). In the present embodiment, with respect to the elements that are specified by the part information 230, display feasibility information 250, and display mode information 260 of the reference table 200a, and that are displayed on an operation screen in two dimensional display, images in the area specified by the display position information 240 are generated as images for two dimensional display.

Next, the range of the coordinates (Xa, Ya) to (Xb, Yb) is designated as a parallax barrier area for two dimensional display (step S207). In the present embodiment, the area that is specified by the display position information 240 is designated as the area to generate a parallax barrier to allow two dimensional display.

Next, a two-dimensional image is overwritten on a three-dimensional image (step S208). In the present embodiment, a two dimensional image that was generated in the process shown in step S206 is overwritten upon a three-dimensional image that was generated in the process shown in step S204.

Next, the parallax barrier area for two dimensional display is overwritten on the parallax barrier area for three dimensional display (step S209). In the present embodiment, the parallax barrier area for two dimensional display that was designated in the process shown in step S207 is overwritten on the parallax barrier area for three dimensional display that was designated in the process shown in step S205.

Then, 3D-2D fusion display is executed (step S210). In the present embodiment, based on the three-dimensional image on which a two-dimensional image was overwritten in the process shown in step S208, and the parallax barrier area for three dimensional display on which the parallax barrier area for two dimensional display was overwritten in the process shown in step S209, an operation screen, on which specific elements are displayed in two dimensional display and the rest of the elements are displayed in three dimensional display, is displayed in the operation panel unit 103.

As described above, according to the processes shown in steps S201 to step S210, an operation screen on which a two-dimensional image is overwritten upon a base of a three-dimensional image is displayed. Note that the technique of combining a parallax barrier for three dimensional display and a parallax barrier for two dimensional display and displaying a three-dimensional image and a two-dimensional image together on the same screen is itself a common technique, and therefore will not be described in detail here.

On the other hand, in the process shown in step S203, in the event the background is determined not to be three dimensional display (step S203: NO), images in the range of the coordinates (0, 0) to (Xmax, Ymax) are generated as images for two dimensional display, and the range of the coordinates (0, 0) to (Xmax, Ymax) is designated as a parallax barrier area for two dimensional display (steps S211 and S212).

Next, images in the range of the coordinates (Xa, Ya) to (Xb, Yb) are generated as images for three dimensional display, and the range of the coordinates (Xa, Ya) to (Xb, Yb) is designated as a parallax barrier area for three dimensional display (steps S213 and S214).

Next, a three-dimensional image is overwritten on a two-dimensional image and the parallax barrier area for three dimensional display is overwritten on the parallax barrier area for two dimensional display (steps S215 and S216).

Then, 3D-2D fusion display is executed (step S210). As a result of this, an operation screen on which specific elements are displayed in three dimensional display, and the rest of the elements are displayed in two dimensional display is displayed in the operation panel unit 103.

As described above, according to the processes shown in step S211 to step S216, an operation screen on which a three-dimensional image is overwritten upon a base of a two-dimensional image is displayed.

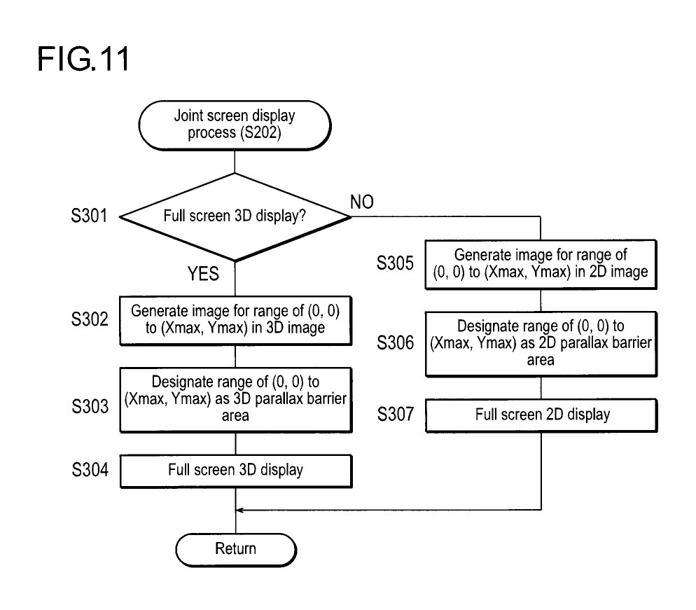

FIG. 11 is a flowchart to show the steps of the joint screen display process shown in step S202 of FIG. 10.

First, whether or not the full screen is three dimensional display is determined (step S301). In the present embodiment, based on the background information 220 of the reference table 200a, whether the full screen is three dimensional display or the full screen is two dimensional display is determined.

In the event it is determined that the full screen is three dimensional display (step S301: YES), images in the range of the coordinates (0, 0) to (Xmax, Ymax) are generated as images for three dimensional display, and the range of the coordinates (0, 0) to (Xmax, Ymax) is designated as a parallax barrier area for three dimensional display (steps S302 and S303).

Then, the full screen is displayed in three dimensional display (step S304). As a result of this, an operation screen on which all the elements are displayed in three dimensional display is displayed in the operation panel unit 103.

On the other hand, in the process shown in step S301, in the event it is determined that the full screen is not three dimensional display (step S301: NO), images in the range of the coordinates (0, 0) to (Xmax, Ymax) are generated as images for two dimensional display, and the range of the coordinates (0, 0) to (Xmax, Ymax) is designated as a parallax barrier area for two dimensional display (steps S305 and S306).

Then, the full screen is displayed in two dimensional display (step S307). As a result of this, an operation screen on which all the elements are displayed in two dimensional display is displayed in the operation panel unit 103.

As described above, according to the processes of the flowcharts shown in FIG. 10 and FIG. 11, based on display information of the reference table 200a, an operation screen on which all elements such as the operation buttons and messages are displayed in three dimensional display, an operation screen on which all the elements are displayed in two dimensional display, or an operation screen on which elements displayed in three dimensional display and elements displayed in two dimensional display exist together, is displayed in the operation panel unit 103.

As described above, according to the present embodiment, an MFP 100, by which a three-dimensional image and a two-dimensional image are combined adequately and displayed on the operation panel unit 103, is provided.

Note that four operation screens have been described as examples with the embodiments described above. However, it is equally possible to display five or more operation screens on the operation panel unit 103. Also, each operation screen may contain elements (parts) other than the elements described above, or may not include part of the elements described above.

### Second Embodiment

With the first embodiment, all elements to constitute the preview screen 320a have been displayed in two dimensional display. However, elements other than a preview image may be displayed in three dimensional display as well.

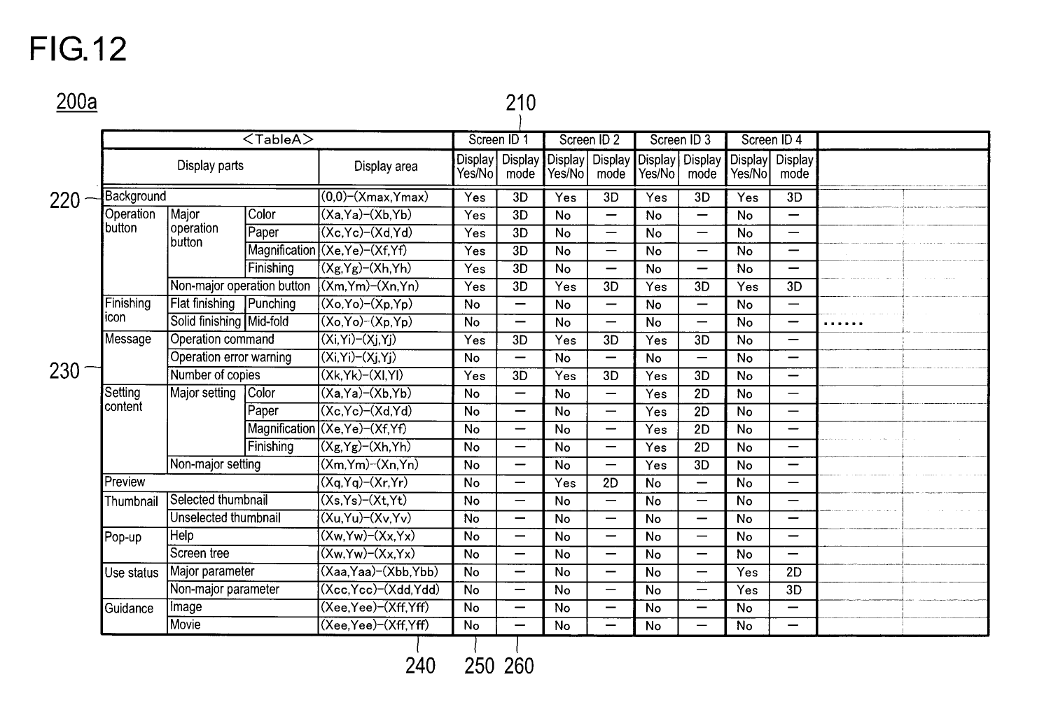

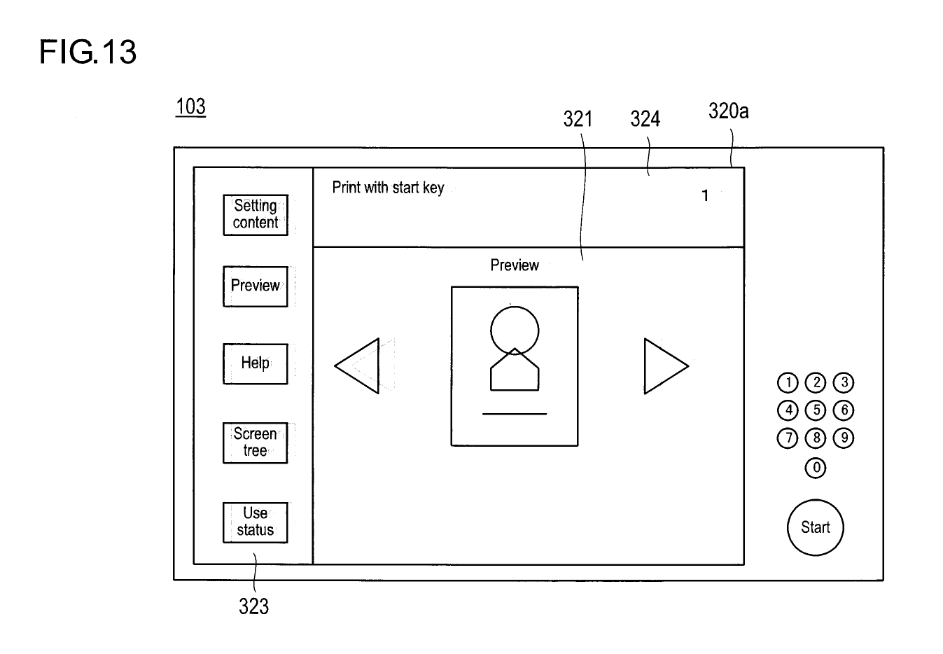

FIG. 12 is a diagram showing a reference table according to the second embodiment of the present invention, and FIG. 13 is a diagram showing a preview screen that is displayed based on the reference table shown in FIG. 12. The structure of the MFP 100 according to the present embodiment is the same as the structure according to the first embodiment, except that the structure of the preview screen is different, and therefore will not be described in detail here.

As shown in FIG. 12 and FIG. 13, with the preview screen 320a of the present embodiment, a preview image is displayed in two dimensional display in the preview image display unit 321, while the rest of the elements are displayed in three dimensional display. Also, the preview screen 320a of the present embodiment does not have a thumbnail image display unit 322 (see FIG. 7) and therefore displays the preview image bigger.

Given this structure, while a plurality of operation screens are displayed in three dimensional display on an overall scale, the user is able to recognize the content of the preview image accurately.

### Third Embodiment

The present embodiment is an embodiment to display thumbnail images on a preview screen.

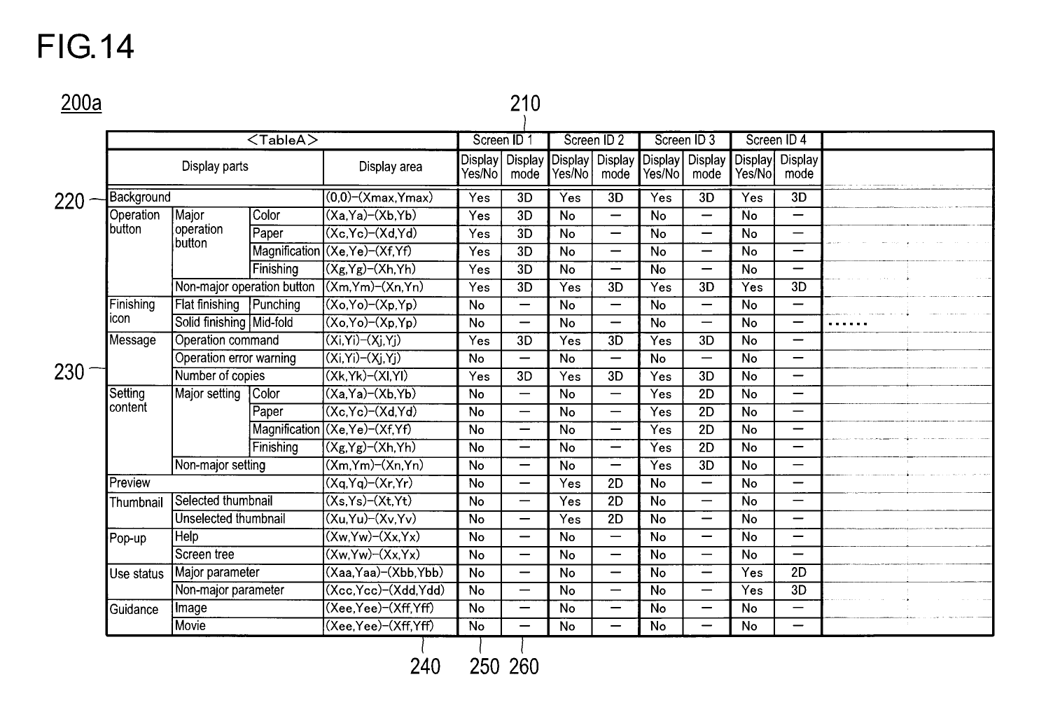

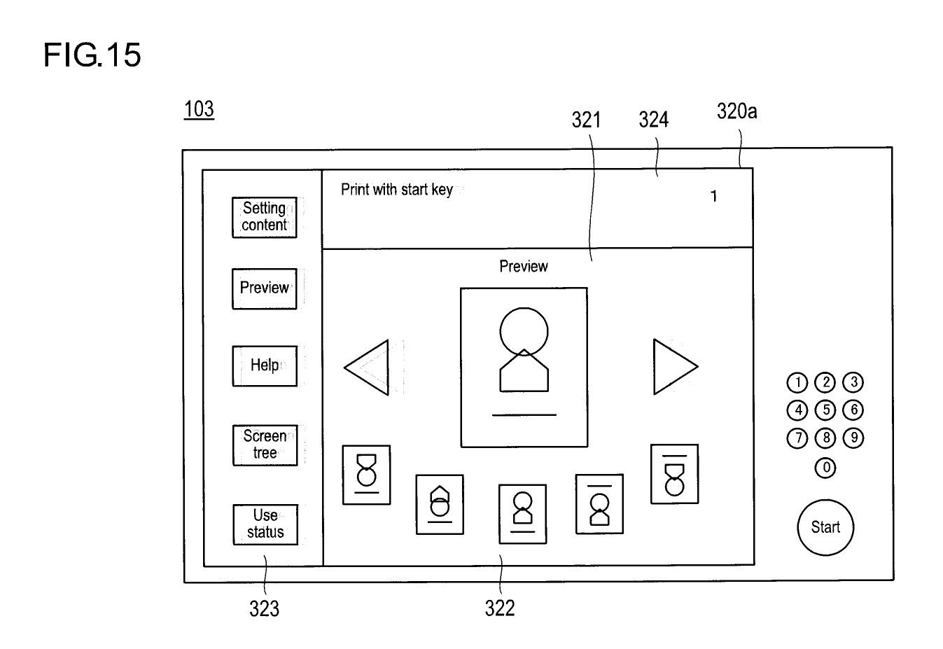

FIG. 14 is a diagram showing a reference table according to the third embodiment of the present invention, and FIG. 15 is a diagram showing a preview screen that is displayed based on the reference table shown in FIG. 14.

As shown in FIG. 14 and FIG. 15, with the preview screen 320a of the present embodiment, a preview image and thumbnail images are displayed in two dimensional display, while the rest of the elements are displayed in three dimensional display.

Given this structure, while a plurality of operation screens are displayed in three dimensional display on an overall scale, the user is able to recognize the content of the preview image and thumbnail images accurately.

### Fourth Embodiment

The present embodiment is an embodiment to display part of thumbnail images in three dimensional display.

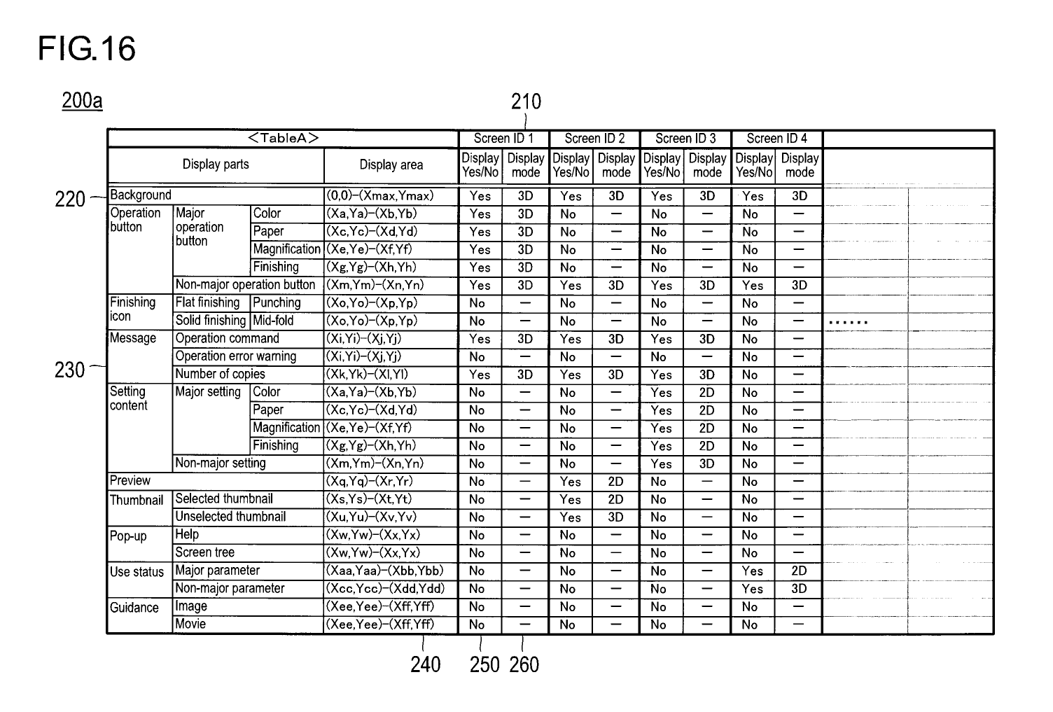

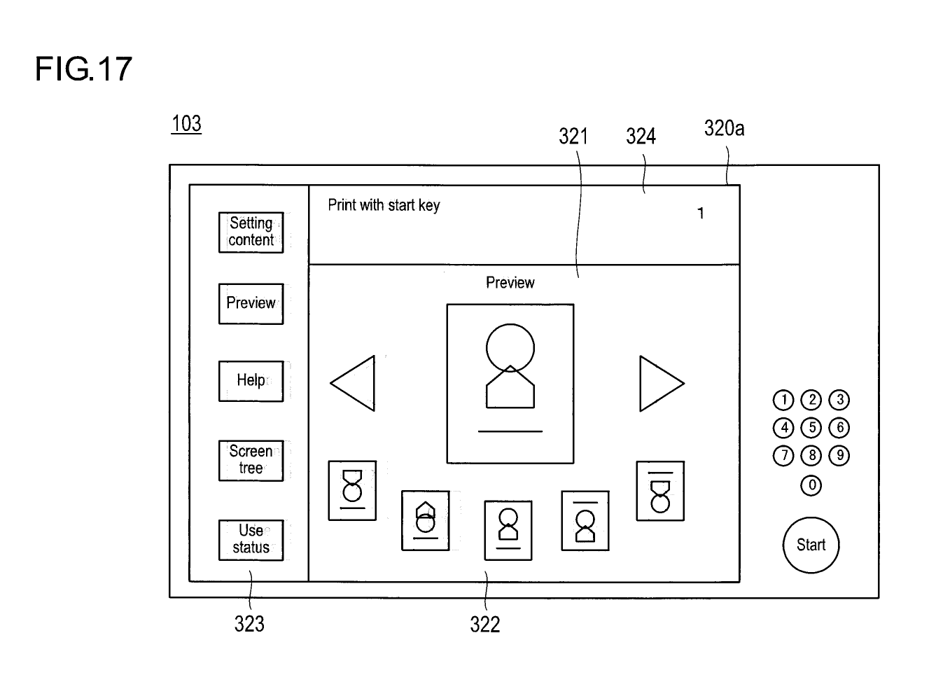

FIG. 16 is a diagram showing a reference table according to the fourth embodiment of the present invention, and FIG. 17 is a diagram showing a preview screen that is displayed based on the reference table shown in FIG. 16.

As shown in FIG. 16 and FIG. 17, the preview screen 320a of the present embodiment displays one thumbnail image among a plurality of thumbnail images, which is selected as a preview image, with the preview image, both in two dimensional display. On the other hand, the rest of the thumbnail images are displayed in three dimensional display.

Given this structure, a thumbnail image that is selected is displayed differently from the other thumbnail images and is therefore emphasized.

### Fifth Embodiment

With the first through fourth embodiments described above, a plurality of operation screens are displayed in three dimensional display on an overall scale. However, a plurality of operation screens may as well be displayed in two dimensional display on an overall scale.

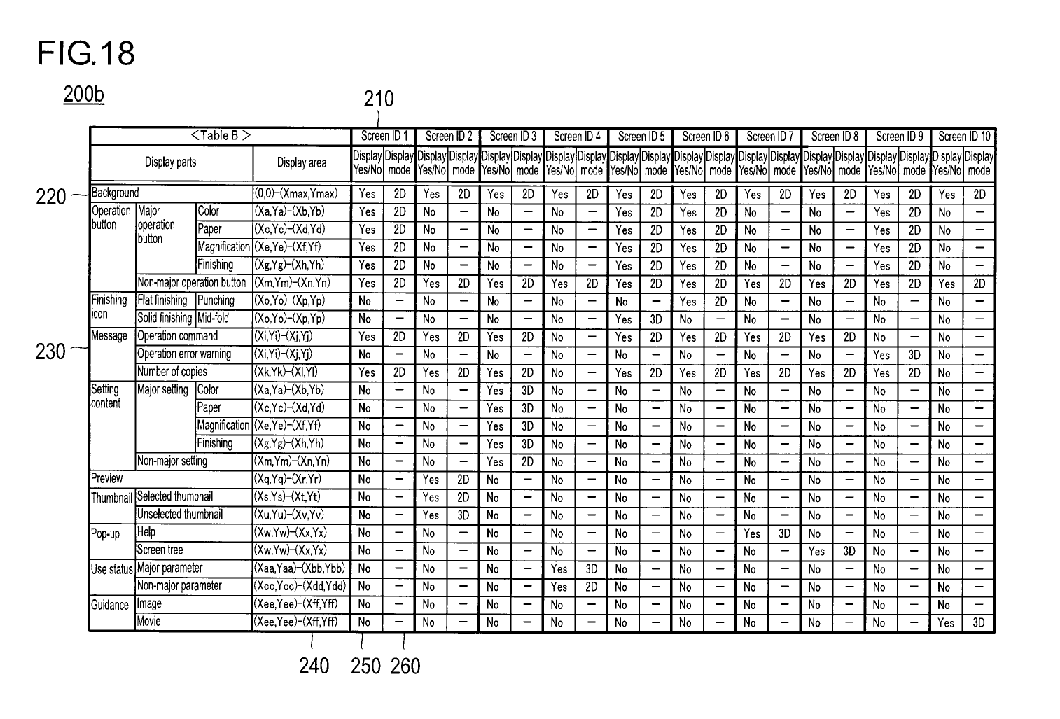

FIG. 18 is a diagram showing a reference table according to the fifth embodiment of the present invention.

As shown in FIG. 18, the reference table 200b of the present embodiment contains screen ID 1 to screen ID 10, as screen ID information 210. Screen ID 1 to screen ID 10 correspond to a standby screen, a preview screen, a setting content check screen, a use status check screen, a 3D-finishing icon display screen, a 2D-finishing icon display screen, a help pop-up screen, a screen tree pop-up screen, an operation error warning screen, and a guidance screen, respectively.

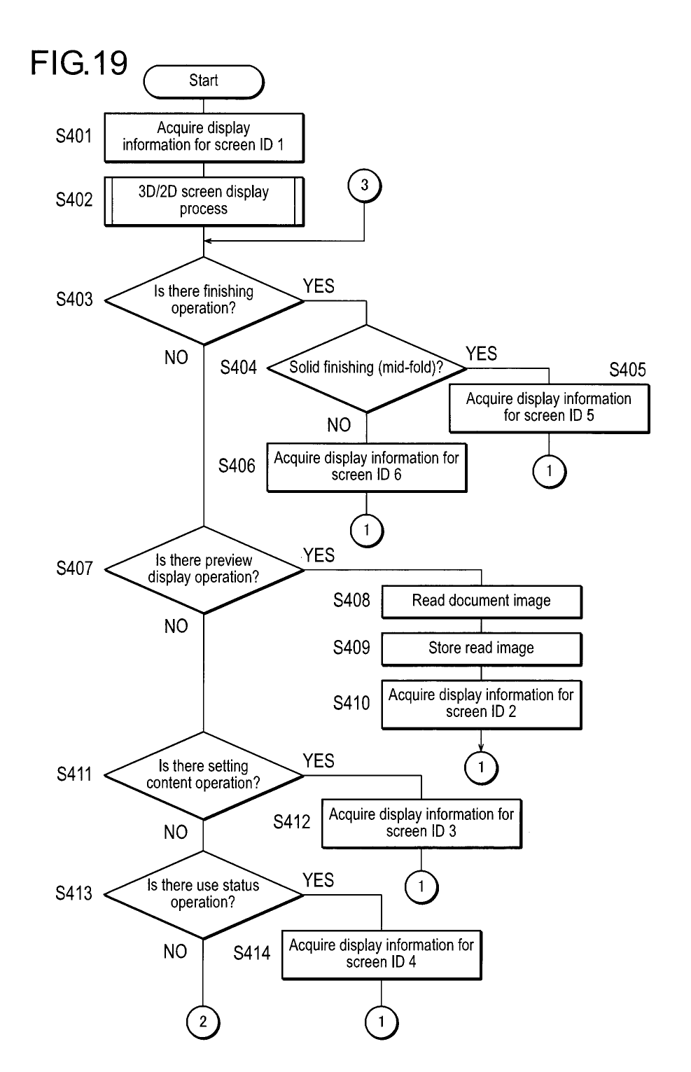

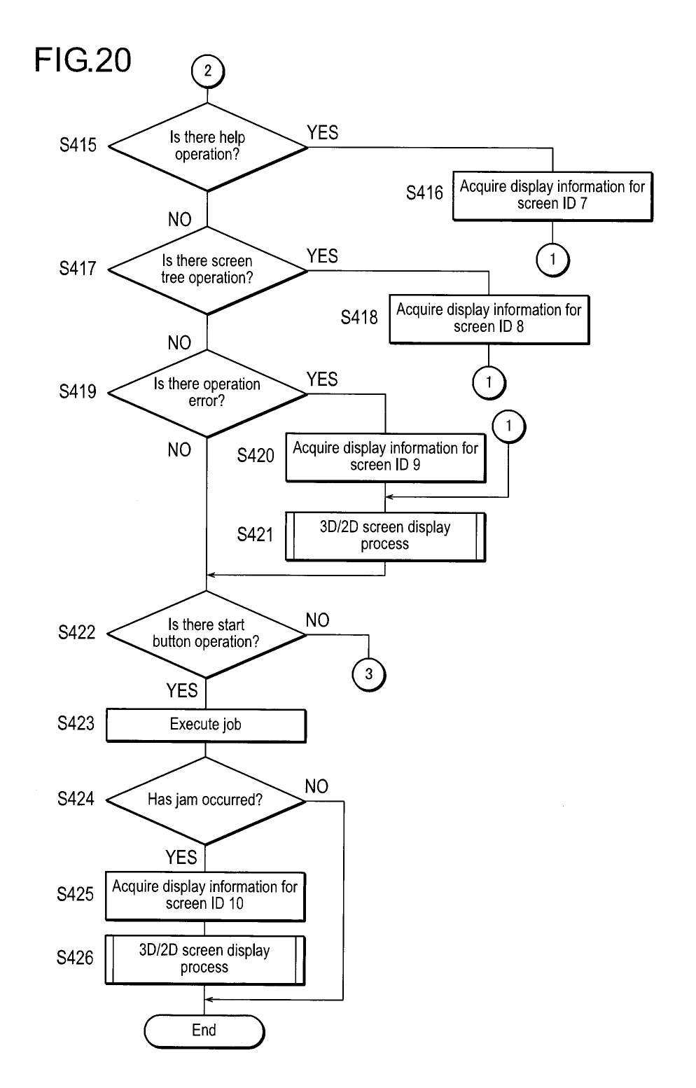

FIG. 19 and FIG. 20 are flowcharts to show the steps of the display control process according to the present embodiment. Note that the algorithm represented by the flowcharts of FIG. 19 and FIG. 20 is stored as a program in the storage unit 102 of the MFP 100, and is executed by the control unit 101.

The processes shown in step S401 and step S402 of FIG. 19 are the same as the processes shown in step S101 and step S102 of FIG. 5, and therefore will not be described.

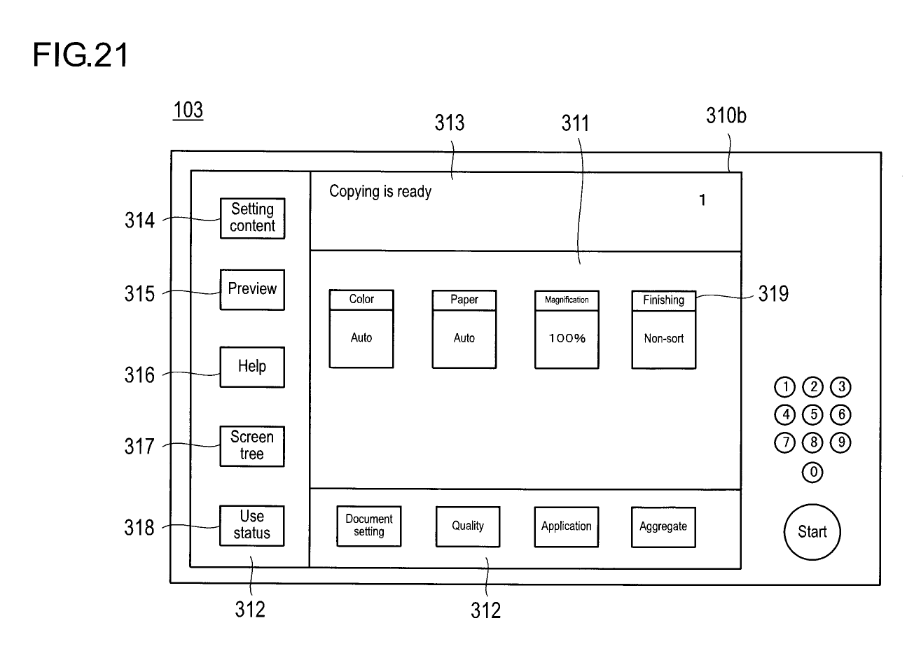

FIG. 21 is a diagram showing a standby screen according to the present embodiment. The standby screen 310b has a major operation button display unit 311, a non-major operation button display unit 312, and a message display unit 313. The standby screen 310b of the present embodiment displays images of the major operation buttons, images of the non-major operation buttons and messages, all in two dimensional display, according to the display mode information 260 of the reference table 200b.

Next, whether or not there is a finishing operation is determined (step S403). In the present embodiment, whether the finishing setting button 319 on the standby screen 310b that was displayed in the process shown in step S402 is touched by the user is determined.

In the event it is determined that there is no finishing operation (step S403: NO), the step moves on to the process of step S407. On the other hand, in the event it is determined that there is a finishing operation (step S403: YES), whether or not it is solid finishing is determined (step S404). In the present embodiment, whether or not the finishing setting button 319 is touched by the user and the folding process is set for post-processing is determined.

In the event it is determined that it is solid finishing (step S404: YES), display information for screen ID 5 is acquired (step S405). In the present embodiment, display information for screen ID 5 is acquired from the reference table 200b.

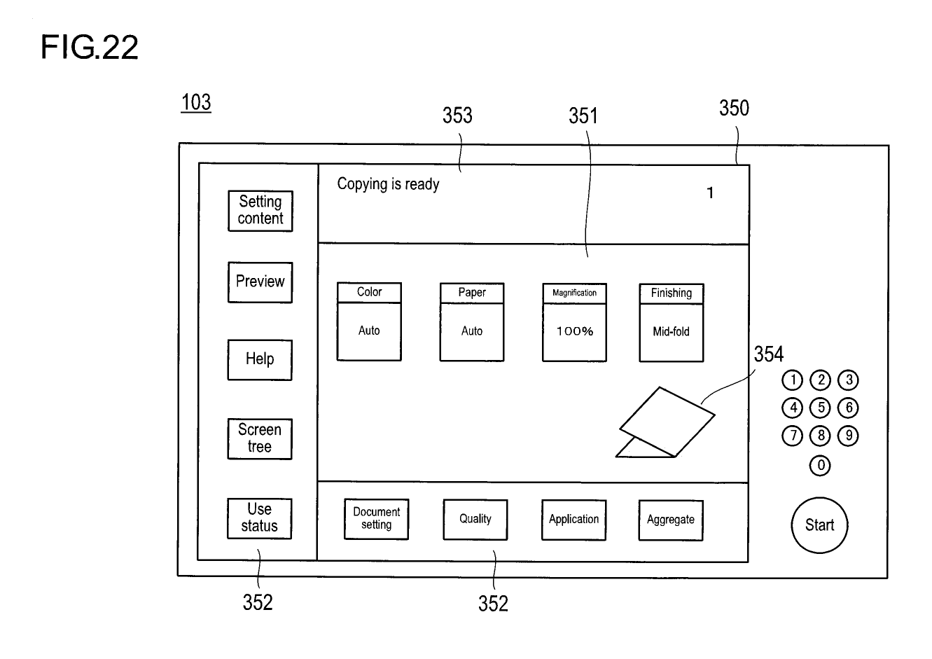

Then, a 3D/2D screen display process is executed (step S421). As the 3D/2D screen display process is executed, a 3D-finishing icon display screen 350 (see FIG. 22) is displayed in the operation panel unit 103.

FIG. 22 is a diagram showing a 3D-finishing icon display screen that is displayed in the operation panel unit. The 3D-finishing icon display screen 350 has a major operation button display unit 351, a non-major operation button display unit 352, and a message display unit 353. Also, the 3D-finishing icon display screen 350 displays an icon 354, which shows the form of the paper that is folded from the center part by the folding process.

The 3D-finishing icon display screen 350 of the present embodiment displays images of the major operation buttons, images of the non-major operation buttons, and messages in two dimensional display, while displaying the icon 354 in three dimensional display, according to the display mode information 260 of the reference table 200b. Given this structure, the icon 354, which is an image to represent the form of the solid paper that is acquired by the folding process, is displayed in three dimensional display, so that the user is able to recognize the result of the folding process easily.

On the other hand, in the process shown in step S404, in the event it is determined that it is not solid finishing (step S404: NO), display information for screen ID 6 is acquired (step S406). In the present embodiment, display information for screen ID 6 is acquired from the reference table 200b.

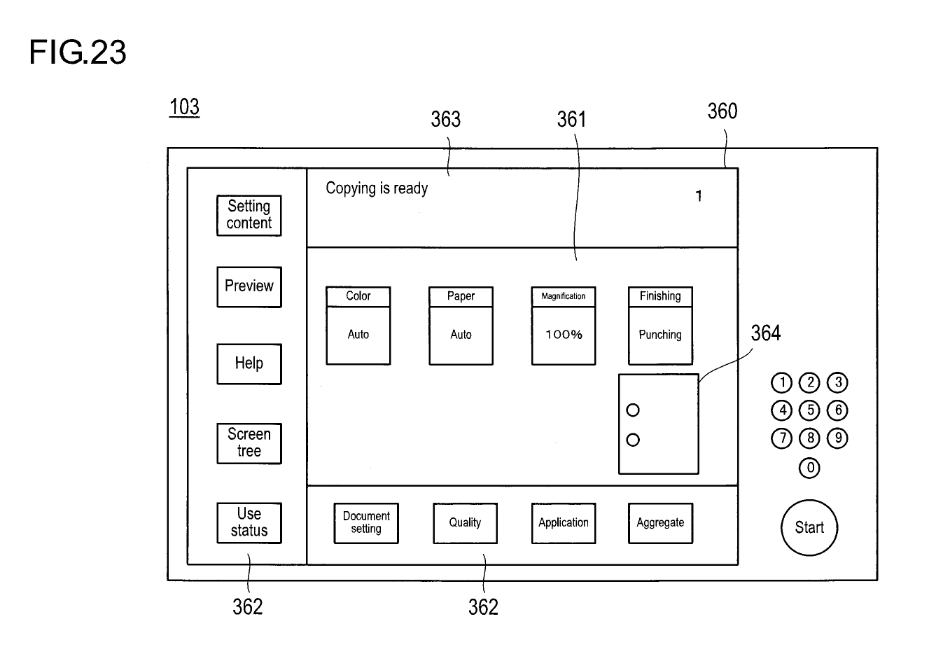

Then, a 3D/2D screen display process is executed (step S421). As the 3D/2D screen display process is executed, a 2D-finishing icon display screen 360 (see FIG. 23) is displayed in the operation panel unit 103.

FIG. 23 is a diagram showing a 2D-finishing icon display screen that is displayed in the operation panel unit. The 2D-finishing icon display screen 360 has a major operation button display unit 361, a non-major operation button display unit 362 and a message display unit 363. Also, the 2D-finishing icon display screen 360 displays an icon 364, which shows the form of the paper on which holes are punched by the punching process.

The 2D-finishing icon display screen 360 of the present embodiment displays images of the major operation buttons, images of the non-major operation buttons, messages and the icon 364, all in two dimensional display, according to the display mode information 260 of the reference table 200b. Given this structure, the icon 364, which is an image to represent the form of the flat paper that is acquired by the punching process, is displayed in two dimensional display, so that the user is able to recognize the result of the punching process easily.

On the other hand, in the process of step S403, in the event it is determined that there is no finishing operation (step S403: NO), the process of step S407 is executed. The processes from step S407 to step S414 in FIG. 19 are the same as the processes shown in step S103 to step S110 in FIG. 5, and therefore will not be described in detail here.

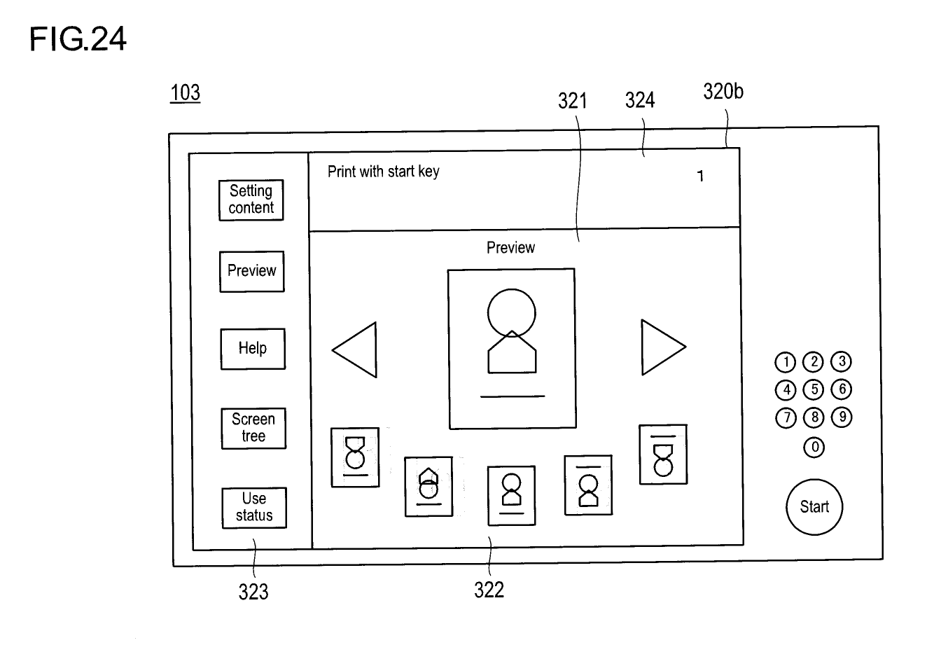

FIG. 24 is a diagram showing a preview screen according to the present embodiment. The preview screen 320b of the present embodiment displays a preview image, images of the non-major operation buttons and messages, in two dimensional display, according to the display mode information 260 of the reference table 200b. Also, among a plurality of thumbnail images, a thumbnail image to be selected as a preview image is displayed in two dimensional display, and the rest of the thumbnail images are displayed in three dimensional display.

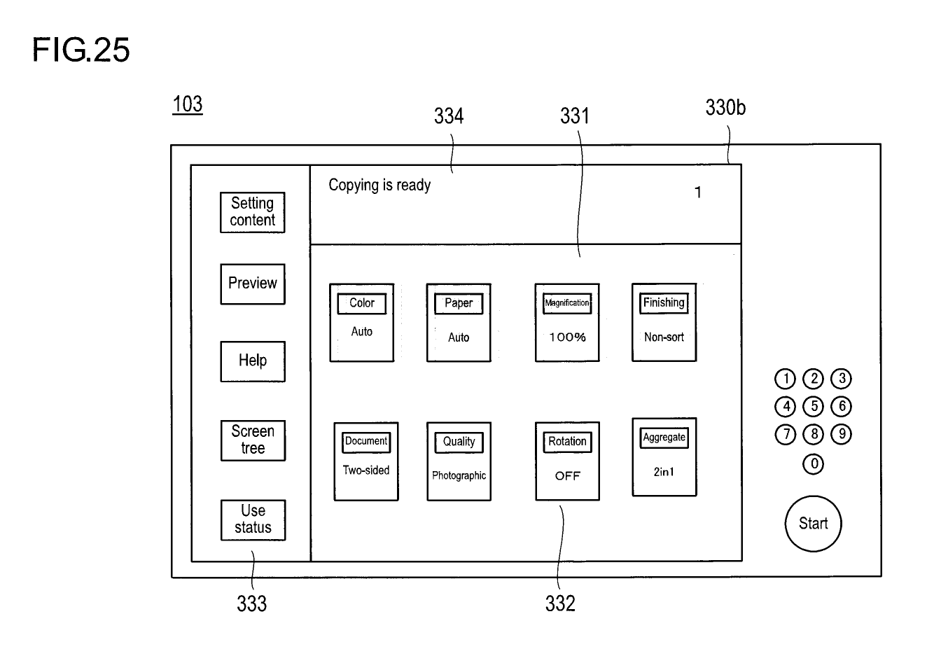

FIG. 25 is a diagram showing setting content check screen according to the present embodiment. The setting content check screen 330b of the present embodiment displays images of the non-major setting buttons, images of the non-major operation buttons, and messages in two dimensional display, while displaying images of the major setting buttons in three dimensional display, according to the display mode information 260 of the reference table 200b.

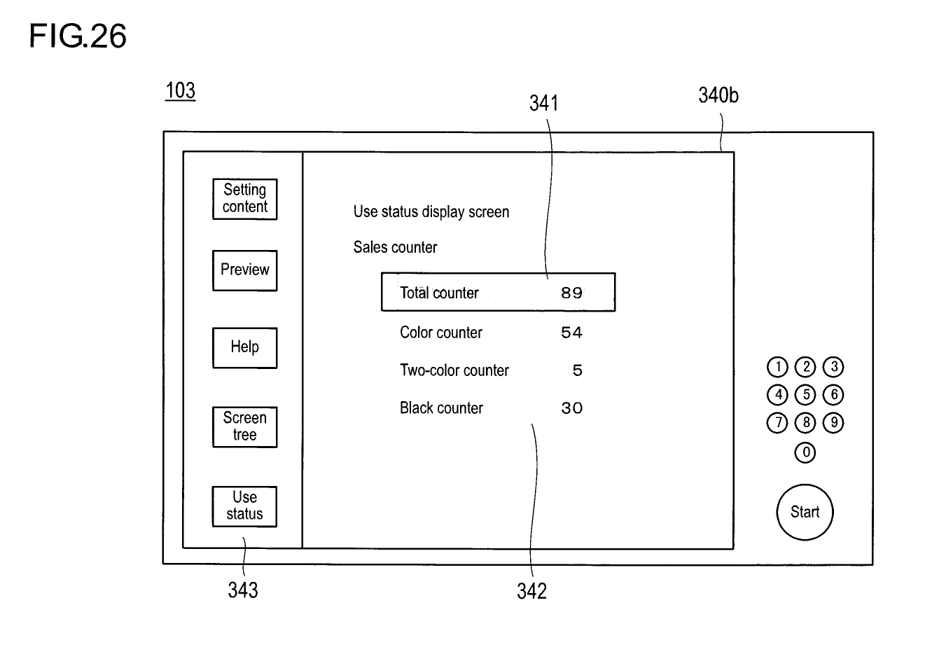

FIG. 26 is a diagram showing a use status check screen according to the present embodiment. The use status check screen 340b of the present embodiment displays the non-major parameters and images of the non-major operation buttons in two dimensional display, while displaying the major parameters in three dimensional display, according to the display mode information 260 of the reference table 200b.

On the other hand, in the process shown in step S413, in the event it is determined that there is no use status check operation (step S413: NO), whether or not there is a help operation is determined (step S415). In the present embodiment, whether or not the help button 316 on the standby screen 310b that was displayed in the process shown in step S402 is touched by the user is determined.

In the event it is determined that there is no help operation (step S415: NO), the step moves on to the process of step S417. On the other hand, in the event it is determined that there is a help operation (step S415: YES), display information for screen ID 7 is acquired (step S416). In the present embodiment, display information for screen ID 7 is acquired from the reference table 200b.

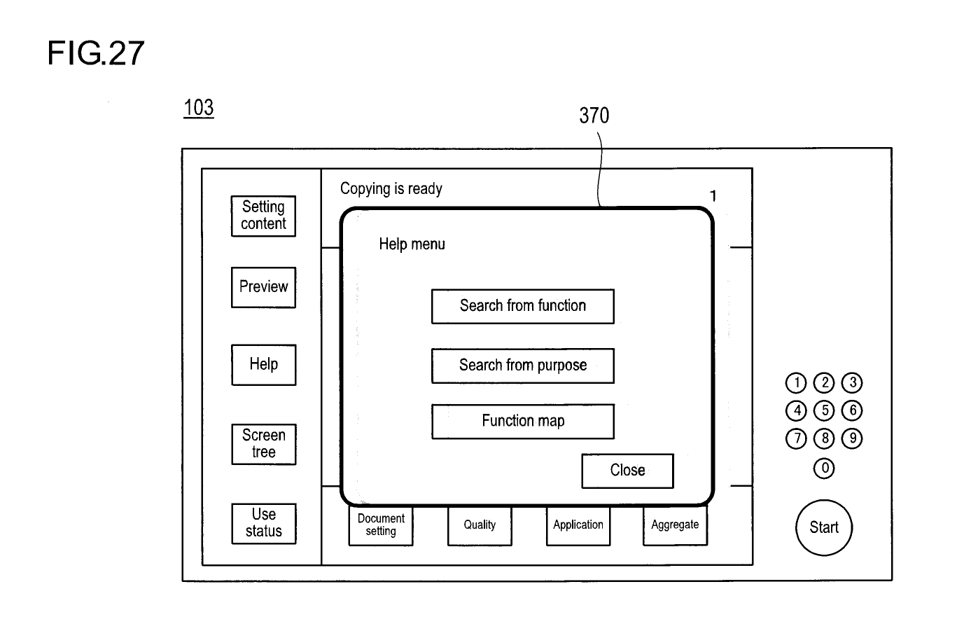

Next, a 3D/2D screen display process is executed (step S421). As the 3D/2D screen display process is executed, a help pop-up screen 370 (see FIG. 27) is displayed in the operation panel unit 103.

FIG. 27 is a diagram showing a help pop-up screen that is displayed in the operation panel unit. The help pop-up screen 370 is displayed in three dimensional display on the standby screen 310b. The help pop-up screen 370 displays, for example, a help menu to allow the user to acquire information as to how to use the MFP 100.

On the other hand, in the process shown in step S415, in the event it is determined that there is no help operation (step S415: NO), whether or not there is a screen tree operation is determined (step S417). In the present embodiment, whether or not the screen tree button 317 on the standby screen 310b that was displayed in the process shown in step S402 is touched by the user is determined.

In the event it is determined that there is no screen tree operation (step S417: NO), the step moves on to the process of step S419. On the other hand, in the event it is determined that there is a screen tree operation (step S417: YES), display information for screen ID 8 is acquired (step S418). In the present embodiment, display information for screen ID 8 is acquired from the reference table 200b.

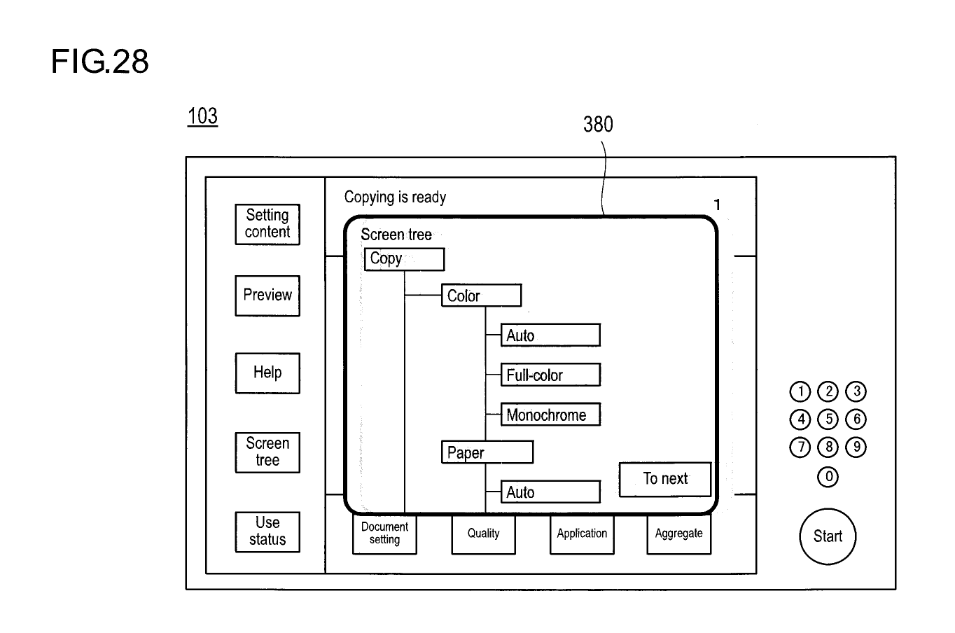

Next, a 3D/2D screen display process is executed (step S421). As the 3D/2D screen display process is executed, a screen tree pop-up screen 380 (see FIG. 28) is displayed in the operation panel unit 103.

FIG. 28 is a diagram showing a screen tree pop-up screen that is displayed in the operation panel unit. The screen tree pop-up screen 380 is displayed in three dimensional display on the standby screen 310b. The screen tree pop-up screen 380 displays, for example, layer information on the operation screen.

On the other hand, in the process shown in step S417, in the event it is determined that there is no screen tree operation (step S417: NO), whether or not there is an operation error is determined (step S419). In the present embodiment, whether or not there is an operation error (for example, there is no paper of the same size as the document) is determined.

In the event it is determined that there is no operation error (step S419: NO), the step moves on to the process of step S422. On the other hand, in the event it is determined that there is an operation error (step S419: YES), display information for screen ID 9 is acquired (step S420). In the present embodiment, display information for screen ID 9 is acquired from the reference table 200b.

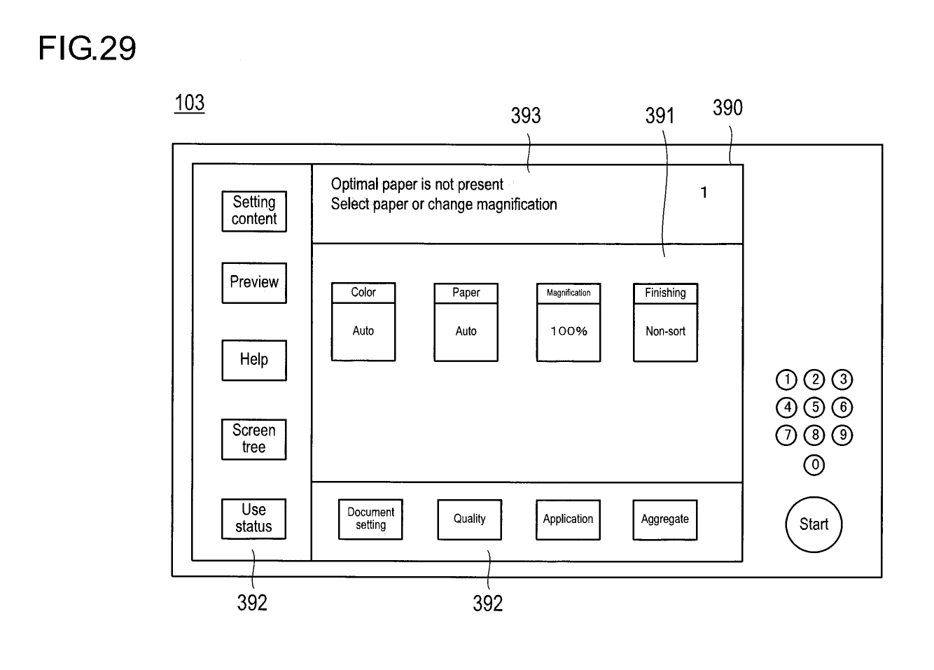

Next, a 3D/2D screen display process is executed (step S421). As the 3D/2D screen display process is executed, an operation error warning screen 390 (see FIG. 29) is displayed in the operation panel unit 103.

FIG. 29 is a diagram showing an operation error warning screen that is displayed in the operation panel unit. The operation error warning screen 390 has a major operation button display unit 391, a non-major operation button display unit 392, and a message display unit 393. The message display unit 393 displays, for example, a message such as an operation error warning to the effect that optimal paper is not present. The operation error warning screen 390 of the present embodiment displays images of the major operation buttons and images of the non-major operation buttons in two dimensional display, while displaying messages in three dimensional display, according to the display mode information 260 of the reference table 200b.

On the other hand, in the process shown in step S419, in the event that it is determined that there is no operation error (step S419: NO), whether or not there is a start button operation is determined (step S422).

In the event it is determined that there is no start button operation (step S422: NO), the step returns to the process of step S403. On the other hand, in the event it is determined that there is a start button operation (step S422: YES), a job is executed (step S423).

Next, whether or not paper jam has occurred is determined (step S424). In the event it is determined that paper jam has not occurred (step S424: NO), the process is finished.

On the other hand, it is determined that paper jam has occurred (step S424: YES), display information for screen ID 10 is acquired (step S425). In the present embodiment, display information for screen ID 10 is acquired from the reference table 200b.

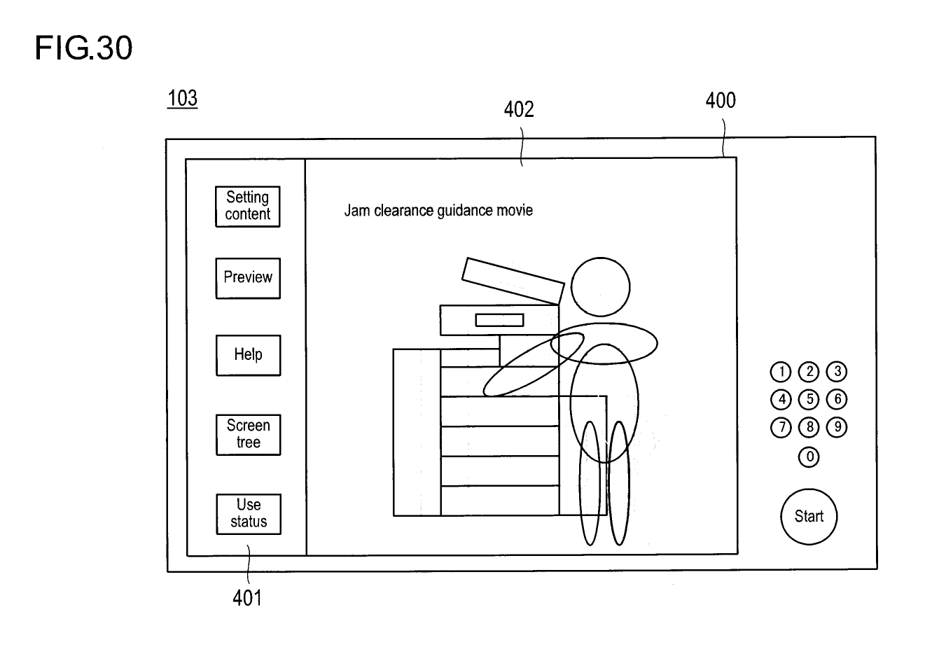

Next, a 3D/2D screen display process is executed (step S426). As the 3D/2D screen display process is executed, a guidance screen 400 (see FIG. 30) is displayed in the operation panel unit 103.

FIG. 30 is a diagram showing a guidance screen that is displayed in the operation panel unit. The guidance screen 400 has a non-major operation button display unit 401 and a guidance movie display unit 402.

The guidance movie display unit 402 displays information to show the status of problems with the MFP 100, a moving image (instructional image) to show the cancellation steps to assist the user to cancel the problems, and so on. The guidance screen 400 displays images of the non-major operation buttons in two dimensional display, while displaying a moving image in three dimensional display.

Given this structure, the work steps for the MFP 100, which is a solid object, are displayed in three dimensional display, so that the user is able to easily understand the part to work on, and so on.

### Sixth Embodiment

With the fifth embodiment, a moving image has been displayed on the guidance screen. However, the guidance screen might as well display still images.

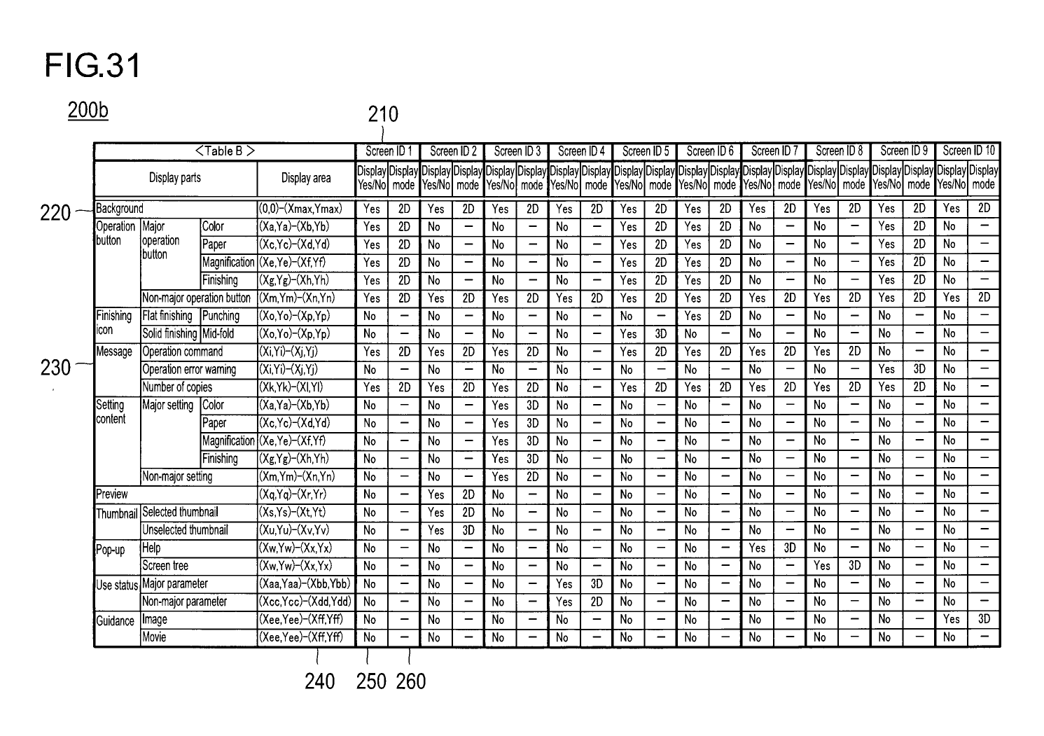

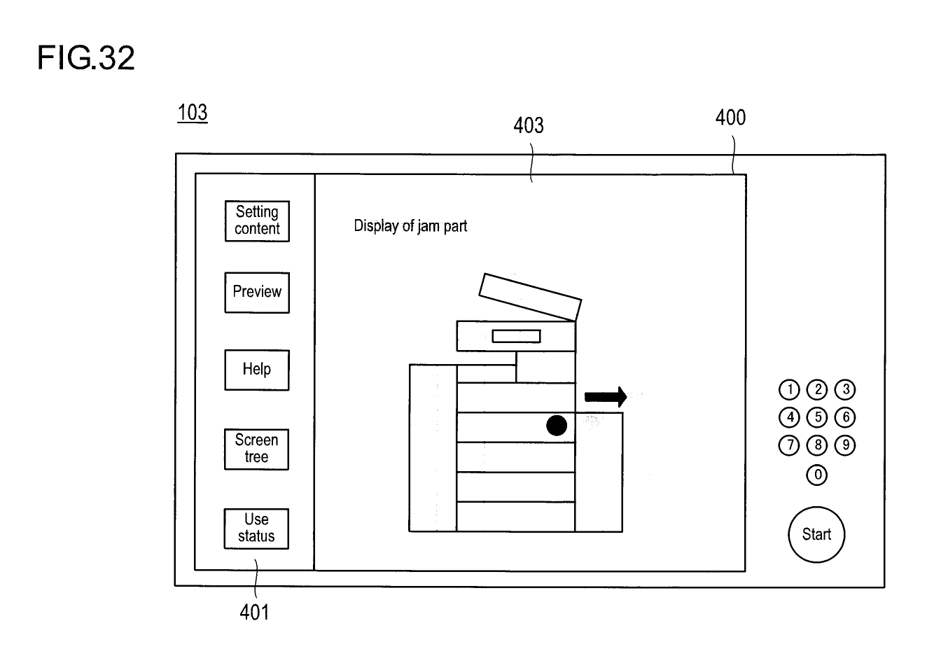

FIG. 31 is a diagram showing a reference table according to the sixth embodiment of the present invention, and FIG. 32 is a diagram showing a guidance screen that is displayed based on the reference table shown in FIG. 31.

As shown in FIG. 31 and FIG. 32, guidance screen 400 of the present embodiment has a non-major operation button display unit 401 and a guidance image display unit 403. The guidance image display unit 403 displays information to show the status of problems with the MFP 100, a still image (instructional image) to show the cancellation steps to assist the user to cancel the problems, and so on. The guidance screen 400 of the present embodiment displays images of the non-major operation buttons in two dimensional display, while displaying still images in three dimensional display.

### Seventh Embodiment

The present embodiment is an embodiment to select the display operation mode of the MFP 100.

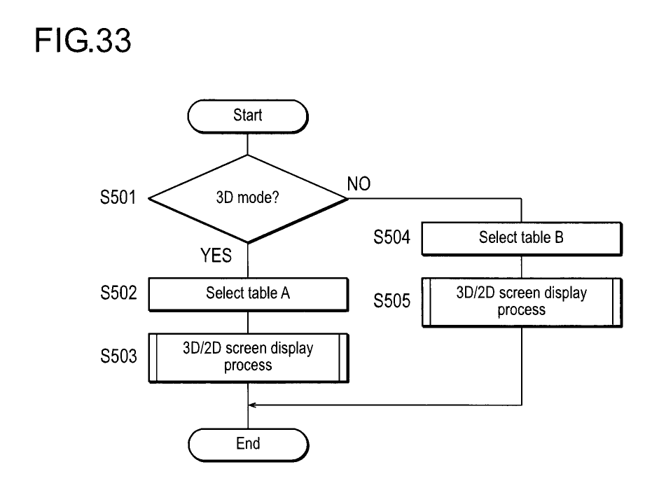

FIG. 33 is a flowchart to show the steps of the display operation mode selection process executed by the MFP. Note that the algorithm represented by the flowchart of FIG. 33 is stored as a program in the storage unit 102 of the MFP 100, and is executed by the control unit 101.

First, whether or not the display operation mode is three dimensional mode is determined (step S501). In the present embodiment, whether the display operation mode of the MFP 100 is three dimensional mode or two dimensional mode is determined, based on the setting information that is set in advance by the administrator's mode.

In the event the display operation mode is determined to be three dimensional mode (step S501: YES), a reference table 200a is selected (step S502). In the present embodiment, the reference table 200a shown in FIG. 4 is selected, and display information for screen ID 1 is acquired.

Next, a 3D/2D screen display process is executed (step S503). As the 3D/2D screen display process is executed, a standby screen 310a (see FIG. 6) to display each element in three dimensional display is displayed in the operation panel unit 103.

On the other hand, in the process shown in step S501, in the event the display operation mode is determined not to be three dimensional mode (step S501: NO), the reference table 200b is selected (step S504). In the present embodiment, the reference table 200b shown in FIG. 18 is selected, and display information for screen ID 1 is acquired.

Next, a 3D/2D screen display process is executed (step S505). As the 3D/2D screen display process is executed, a standby screen 310b (see FIG. 21) to display each element in two dimensional display is displayed in the operation panel unit 103.

Given this structure, it is possible to switch the display operation mode of the MFP 100 in a way the user desires.

### Eighth Embodiment

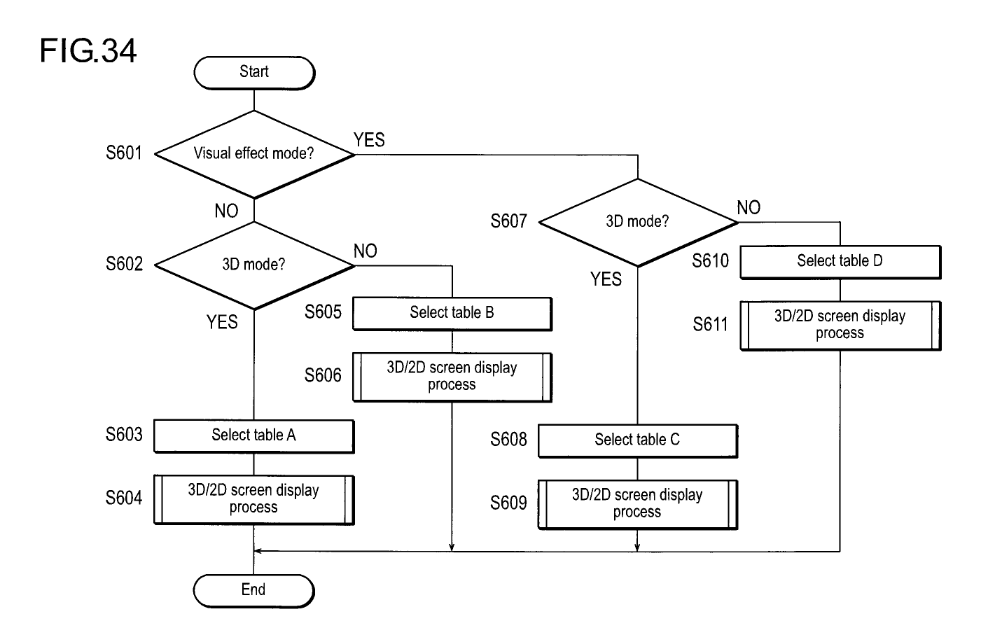

Next, the eighth embodiment of the present invention will be described with reference to FIG. 34 to FIG. 38. The present embodiment is an embodiment to display an operation screen having a visual effect.

FIG. 34 is a flowchart to show the steps of the display operation mode selection process according to the present embodiment.

First, whether or not the display operation mode is visual mode is determined (step S601). In the present embodiment, whether or not the display operation mode of the MFP 100 is visual mode is determined, based on the setting information that is set in advance by the administrator's mode.

In the event the display operation mode is determined not to be visual mode (step S601: NO), the process of step S602 is executed. The processes shown in step S602 to step S606 in FIG. 34 are the same as the processes shown in step S501 to S505 in FIG. 33, and therefore will not be described here.

On the other hand, in the process shown in step S601, in the event the display operation mode is determined to be visual mode (step S601: YES), whether or not the display operation mode is three dimensional mode is determined (step S607).

In the event the display operation mode is determined to be three dimensional mode (step S607: YES), a visual mode first reference table 200c is selected, and a 3D/2D screen display process is executed (steps S608 and S609).

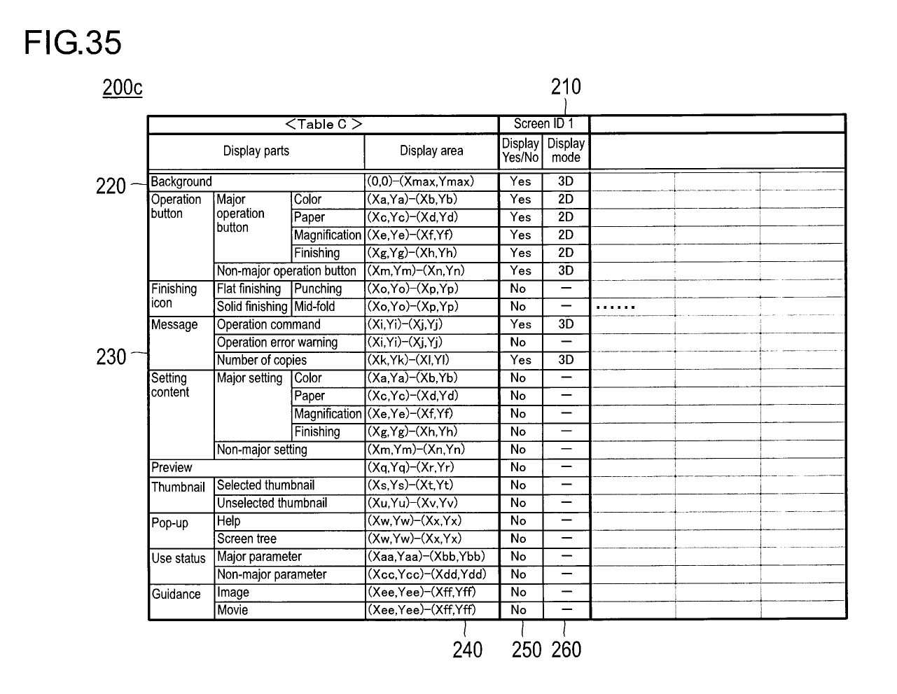

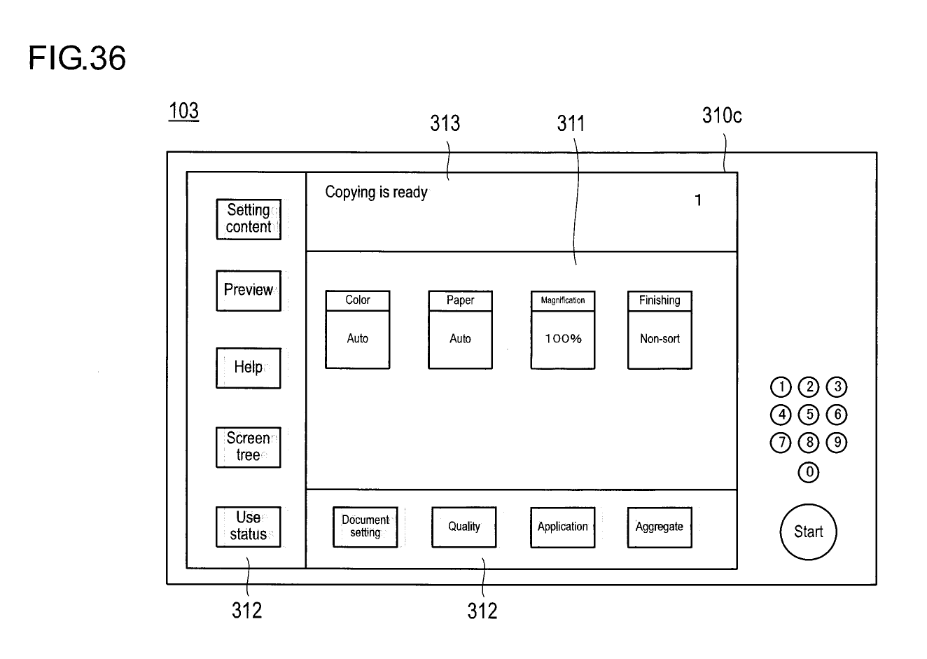

FIG. 35 is a diagram showing a visual mode first reference table, and FIG. 36 is a diagram showing a standby screen that is displayed based on the visual mode first reference table shown in FIG. 35.

As shown in FIG. 35 and FIG. 36, the standby screen 310c displays images of the non-major operation buttons and messages in three dimensional display, while displaying images of the major operation buttons in two dimensional display, according to the display mode information 260 of the visual mode first reference table 200c.

Given this structure, the major operation buttons are emphasized. Also, the major operation buttons are displayed clearly as two-dimensional images of high resolution, and a sense of depth of the major operation buttons that are displayed is lost. As a result of this, there is little error between the display range and the detection range, and the unnatural feeling that arises from the deviation between vision and the sense of touch when the user touches the standby screen 310c is reduced.

On the other hand, in the process shown in step S607, in the event the display operation mode is determined not to be three dimensional mode (step S607: NO), a visual mode second reference table 200d is selected, and a 3D/2D screen display process is executed (steps S610 and S611).

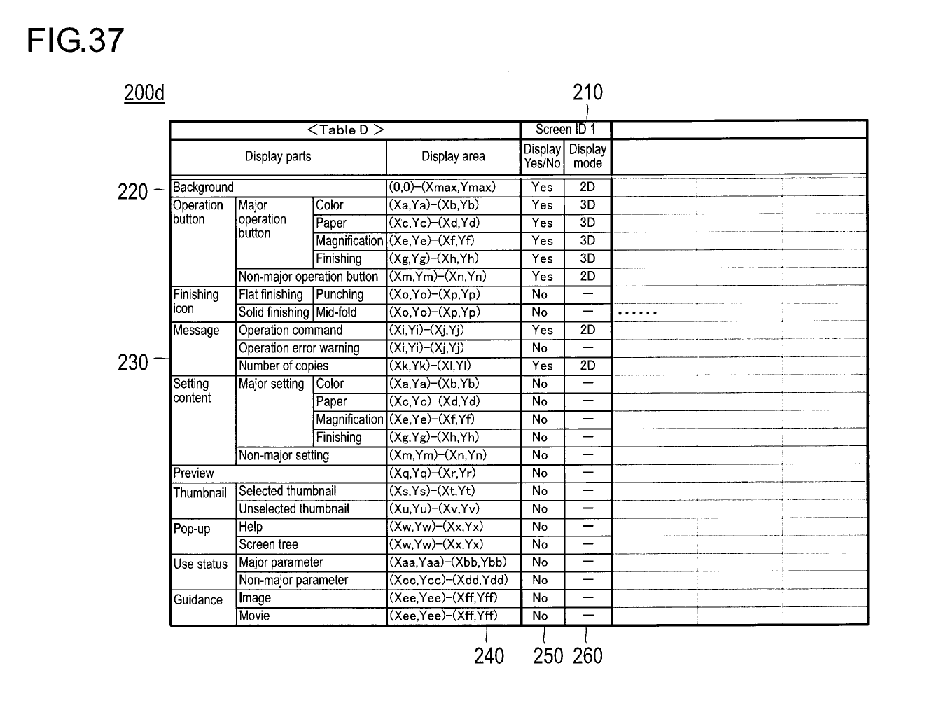

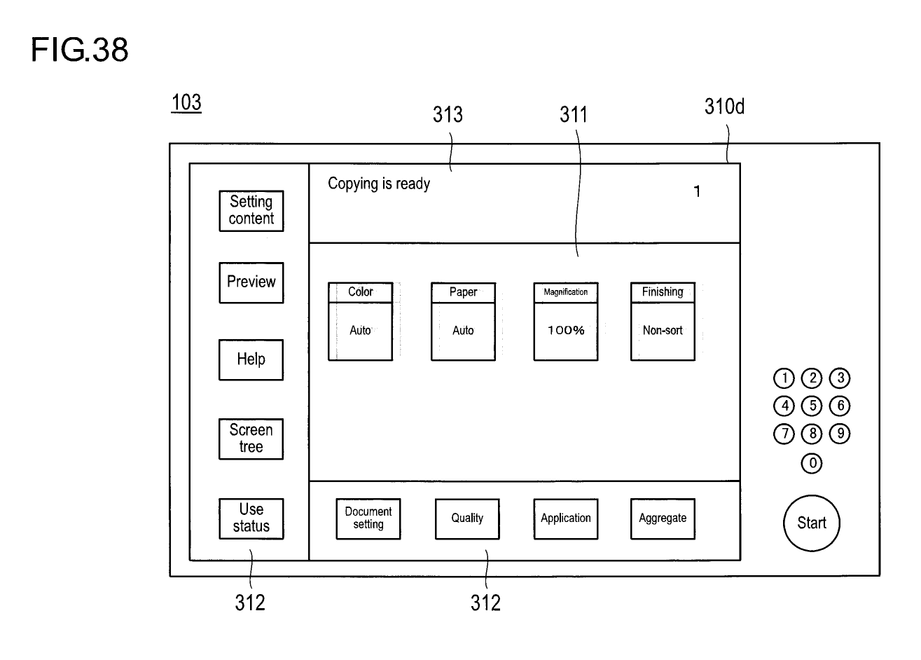

FIG. 37 is a diagram showing a visual mode second reference table, and FIG. 38 is a diagram showing a standby screen that is displayed based on the visual mode second reference table shown in FIG. 37.

As shown in FIG. 37 and FIG. 38, the standby screen 310d displays images of the non-major operation buttons and messages in two dimensional display, while displaying images of the major operation buttons in three dimensional display, according to the display mode information 260 of the visual mode second reference table 200d. Given this structure, the major operation buttons, which are images, are recognized in the same way as physical buttons.

As described above, according to the first to eighth embodiments of the present invention, an MFP 100, by which a three-dimensional image and a two-dimensional image are combined adequately and displayed on the operation panel unit 103, is provided.

The present invention is by no means limited to the first to eighth embodiments described above, and can be modified or altered in various ways within the scope of claims.

For example, with the first to eighth embodiments described above, an image that is based on image data that is acquired by reading an image on a document is displayed as a preview image on a preview screen. However, a preview image may be image that is based on image data that is based on a print job or image data that is received by facsimile.

Also, cases have been described above with the first to eighth embodiments where a three dimensional stereoscopic image that can be recognized by naked eyes is displayed using a parallax barrier. However, as the scheme of displaying three dimensional stereoscopic images, it is possible to use various schemes, such as, for example, a scheme of displaying using dedicated glasses.

Also, with the seventh and eighth embodiments described above, three dimensional display and two dimensional display of an operation screen such as a standby screen and so on are switched according to the user's preferences. However, it is equally possible to switch between three dimensional display and two dimensional display per element to constitute the operation screen.

Also, cases have been described above with the first to eighth embodiments where the present invention is applied to an MFP. However, the present invention may be applied to a copy machine and a printer as well.

The units and methods to perform various processes in the image forming apparatus according to the above embodiments may be implemented by either dedicated hardware circuits or a programmed computer. The above program may be provided by means of, for example, a computer readable recording mediums such as a flexible disk or CD-ROM, or may be provided online via a network such as the Internet. In this case, the program that is recorded in the computer readable recording medium is transferred to a storage unit such as a hard disk and stored therein. Also, the above program may be provided as single application software or may be incorporated as one function of an image forming apparatus, in the software of this apparatus.

What is claimed is:

1. An image forming apparatus comprising:
a display unit capable of switching and displaying a plurality of operation screens, including an operation screen to display elements constituting the operation screen in three dimensional display;
a storage unit that stores image data of a page image;
a receiving unit that receives a command to display the page image in said display unit; and
a display control unit that, when said command is received by said receiving unit and an operation screen for displaying the page image, among said plurality of operation screens, is displayed in said display unit, generates the page image based on the image data that is stored in said storage unit, on the operation screen, as an image for two dimensional display.

2. The image forming apparatus as claimed in claim 1, wherein,
said storage unit stores image data of a plurality of page images,
on said operation screen for displaying the page image, a plurality of thumbnail images corresponding to the image data of said plurality of page images are generated, and the page image that is displayed in two dimensional display is a page image corresponding to one thumbnail image that is selected from among said plurality of thumbnail images; and
said display control unit further executes a control for generating said one thumbnail image that is selected from said plurality of thumbnail images as an image for two dimensional display, and generating rest of the thumbnail images as images for three dimensional display.

3. The image forming apparatus as claimed in claim 1, further comprising:
an image forming unit that forms an image based on the image data on a recording medium; and
a post-processing unit that applies post-processing to the recording medium on which the image is formed by said image forming unit, wherein,
said plurality of operation screens include an operation screen for setting up the post-processing; and
said display control unit further executes a control for generating, according to the content of the post-processing, an image to represent a form of the recording medium to which the post-processing of said content has been applied, as an image for three dimensional display or as an image for two dimensional display, on said operation screen for setting up the post-processing.

4. The image forming apparatus as claimed in claim 1, wherein,
said plurality of operation screens include an operation screen for displaying a message for a user, and
said display control unit further executes a control for generating said message as an image for three dimensional display, on said operation screen for displaying the message.

5. The image forming apparatus as claimed in claim 1, wherein,
said plurality of operation screens include an operation screen for displaying an instructional image for instructing a method of cancelling an error that has occurred in said image forming apparatus to a user, and
said display control unit further executes a control for generating said instructional image as an image for three dimensional display, on said operation screen for displaying the instructional image.

6. A non-transitory computer readable recording medium stored with a control program for an image forming apparatus comprising a display unit capable of switching and displaying a plurality of operation screens, including an operation screen to display elements constituting the operation screen in three dimensional display, and a storage unit that stores image data of a page image, said program causing said image forming apparatus to execute a process comprising:
(a) receiving a command to display the page image in said display unit; and
(b) when said command is received in step (a) and an operation screen for displaying the page image, among said plurality of operation screens, is displayed in said display unit, generating the page image based on the image data that is stored in said storage unit, on the operation screen, as an image for two dimensional display.

7. The non-transitory computer readable recording medium as claimed in claim 6, wherein,
said storage unit stores image data of a plurality of page images,
on said operation screen for displaying the page image, a plurality of thumbnail images corresponding to the image data of said plurality of page images are generated, and the page image that is displayed in two dimensional display is a page image corresponding to one thumbnail image that is selected from among said plurality of thumbnail images; and
in step (b), a control for generating said one thumbnail image that is selected from said plurality of thumbnail images as an image for two dimensional display, and generating rest of the thumbnail images as images for three dimensional display is further executed.

8. The non-transitory computer readable recording medium as claimed in claim 6, wherein,
said image forming apparatus further comprises:
an image forming unit that forms an image based on the image data on a recording medium; and
a post-processing unit that applies post-processing to the recording medium on which the image is formed by said image forming unit;
said plurality of operation screens include an operation screen for setting up the post-processing; and
said process further comprises:
(c) generating, according to the content of the post-processing, an image to represent a form of the recording medium to which the post-processing of said content has been applied, as an image for three dimensional display or as an image for two dimensional display, on said operation screen for setting up the post-processing.

9. The non-transitory computer readable recording medium as claimed in claim 6, wherein,
said plurality of operation screens include an operation screen for displaying a message for a user, and
said process further comprises:
(d) generating said message as an image for three dimensional display, on said operation screen for displaying the message.

10. The non-transitory computer readable recording medium as claimed in claim 6, wherein:
said plurality of operation screens include an operation screen for displaying an instructional image for instructing a method of cancelling an error that has occurred in said image forming apparatus to a user, and
said process further comprises:
(e) generating said instructional image as an image for three dimensional display, on said operation screen for displaying the instructional image.
